(19) United States
(12) Patent Application Publication
(10) Pub. No.: US 2024/0163916 A1
(43) Pub. Date: May 16, 2024

(54) Termination of Target Wake Time Service Period

(71) Applicant: Ofinno, LLC, Reston, VA (US)

(72) Inventors: Kiseon Ryu, McLean, VA (US); Jeongki Kim, Fairfax, VA (US); Esmael Hejazi Dinan, McLean, VA (US)

(73) Assignee: Ofinno, LLC, Reston, VA (US)

(21) Appl. No.: 18/416,954

(22) Filed: Jan. 19, 2024

Related U.S. Application Data
(63) Continuation of application No. PCT/US2022/038618, filed on Jul. 28, 2022.
(60) Provisional application No. 63/328,335, filed on Apr. 7, 2022.
(60) Provisional application No. 63/236,484, filed on Aug. 24, 2021.
(60) Provisional application No. 63/236,495, filed on Aug. 24, 2021.
(60) Provisional application No. 63/227,431, filed on Jul. 30, 2021.
(60) Provisional application No. 63/227,434, filed on Jul. 30, 2021.

(51) Int. Cl. H04W 74/04; H04W 28/02; H04W 74/08; H04W 74/0816

(52) U.S. Cl. CPC H04W 74/04; H04W 28/0268; H04W 74/0816; H04W 74/0866

(57) ABSTRACT

A station (STA) transmits to an access point (AP) a setup request frame indicating one or more first traffic identifiers (TIDs) associated with a trigger-enabled restricted target wake time (r-TWT) service period (SP). The STA receives from the AP a setup response frame indicating one or more second TIDs associated with the trigger-enabled r-TWT SP. The STA receives from the AP a first frame indicating a trigger-enabled r-TWT SP for the STA. Based on not receiving a second frame from the AP during a first time period within the trigger-enabled r-TWT SP, the STA transmits a non-trigger based frame following the first time period. The non-trigger based frame causes termination of the r-TWT SP.

### CROSS-REFERENCE TO RELATED APPLICATIONS

This application is a continuation of International Application No. PCT/US2022/038618, filed Jul. 28, 2022, which claims the benefit of U.S. Provisional Application No. 63/227,431, filed Jul. 30, 2021, U.S. Provisional Application No. 63/227,434, filed Jul. 30, 2021, U.S. Provisional Application No. 63/236,484, filed Aug. 24, 2021, U.S. Provisional Application No. 63/236,495, filed Aug. 24, 2021, and U.S. Provisional Application No. 63/328,335, filed Apr. 7, 2022, all of which are hereby incorporated by reference in their entireties.

### BRIEF DESCRIPTION OF THE DRAWINGS

Examples of several of the various embodiments of the present disclosure are described herein with reference to the drawings.

FIG. 1 illustrates example wireless communication networks in which embodiments of the present disclosure may be implemented.

FIG. 2 is a block diagram illustrating example implementations of a station (STA) and an access point (AP).

FIG. 3 illustrates an example of target wake time (TWT) operation.

FIG. 4 illustrates an example of TWT operation in an environment including an AP multi-link device (AP MLD) and a non-AP multi-link device (non-AP MLD).

FIG. 5 illustrates an example TWT element which may be used to support individual TWT operation.

FIG. 6 illustrates an example TWT element which may be used to support restricted TWT operation.

FIG. 7 illustrates an example of individual TWT operation.

FIG. 8 illustrates an example of broadcast TWT operation.

FIG. 9 illustrates an example of TWT protection in individual TWT operation.

FIG. 10 illustrates an example of restricted TWT operation.

FIG. 11 illustrates an example of existing restricted TWT (r-TWT) operation.

FIG. 12 illustrates an example of existing r-TWT operation.

FIG. 13 illustrates an example of existing r-TWT operation.

FIG. 14 illustrates an example of r-TWT service period (SP) termination according to an embodiment.

FIG. 15 illustrates an example of r-TWT operation according to an embodiment.

FIG. 16 illustrates examples methods of determining a first time period and/or a second time period.

FIG. 17 illustrates an example process for r-TWT operation according to an embodiment.

FIG. 18 illustrates an example process for r-TWT operation according to an embodiment.

FIG. 19 illustrates an example of trigger-enabled r-TWT operation.

FIG. 20 illustrates another example of trigger-enabled r-TWT operation.

FIG. 21 illustrates an example of trigger-enabled r-TWT operation according to an embodiment.

FIG. 22 illustrates an example TWT operation.

FIG. 23 illustrates an example r-TWT SP operation.

FIG. 24 illustrates an example r-TWT SP operation.

FIG. 25 illustrates an example r-TWT operation according to an embodiment.

FIG. 26 illustrates an example r-TWT operation according to an embodiment.

FIG. 27 illustrates an example r-TWT operation according to an embodiment.

FIG. 28 illustrates an example r-TWT operation according to an embodiment.

FIG. 29 illustrates an example r-TWT operation according to an embodiment.

FIG. 30 illustrates an example r-TWT operation according to an embodiment.

FIG. 31 illustrates an example aggregated control field which may be used to indicate termination of an r-TWT SP.

FIG. 32 illustrates an example process for r-TWT operation according to an embodiment.

FIG. 33 illustrates an example process for r-TWT operation according to an embodiment.

FIG. 34 illustrates an example process for r-TWT operation according to an embodiment.

### DETAILED DESCRIPTION

In the present disclosure, various embodiments are presented as examples of how the disclosed techniques may be implemented and/or how the disclosed techniques may be practiced in environments and scenarios. It will be apparent to persons skilled in the relevant art that various changes in form and detail can be made therein without departing from the scope. After reading the description, it will be apparent to one skilled in the relevant art how to implement alternative embodiments. The present embodiments may not be limited by any of the described exemplary embodiments. The embodiments of the present disclosure will be described with reference to the accompanying drawings. Limitations, features, and/or elements from the disclosed example embodiments may be combined to create further embodiments within the scope of the disclosure. Any figures which highlight the functionality and advantages, are presented for example purposes only. The disclosed architecture is sufficiently flexible and configurable, such that it may be utilized in ways other than that shown. For example, the actions listed in any flowchart may be re-ordered or only optionally used in some embodiments.

Embodiments may be configured to operate as needed. The disclosed mechanism may be performed when certain criteria are met, for example, in a station, an access point, a radio environment, a network, a combination of the above, and/or the like. Example criteria may be based, at least in part, on for example, wireless device or network node configurations, traffic load, initial system set up, packet sizes, traffic characteristics, a combination of the above, and/or the like. When the one or more criteria are met, various example embodiments may be applied. Therefore, it may be possible to implement example embodiments that selectively implement disclosed protocols.

In this disclosure, “a” and “an” and similar phrases are to be interpreted as “at least one” and “one or more.” Similarly, any term that ends with the suffix “(s)” is to be interpreted as “at least one” and “one or more.” In this disclosure, the term “may” is to be interpreted as “may, for example.” In other words, the term “may” is indicative that the phrase following the term “may” is an example of one of a multitude of suitable possibilities that may, or may not, be employed by one or more of the various embodiments. The terms “comprises” and “consists of”, as used herein, enumerate one or more components of the element being described. The term “comprises” is interchangeable with “includes” and does not exclude unenumerated components from being included in the element being described. By contrast, “consists of” provides a complete enumeration of the one or more components of the element being described. The term “based on”, as used herein, may be interpreted as “based at least in part on” rather than, for example, “based solely on”. The term “and/or” as used herein represents any possible combination of enumerated elements. For example, “A, B, and/or C” may represent A; B; C; A and B; A and C; B and C; or A, B, and C.

If A and B are sets and every element of A is an element of B, A is called a subset of B. In this specification, only non-empty sets and subsets are considered. For example, possible subsets of B={STA1, STA2} are: {STA1}, {STA2}, and {STA1, STA2}. The phrase “based on” (or equally “based at least on”) is indicative that the phrase following the term “based on” is an example of one of a multitude of suitable possibilities that may, or may not, be employed to one or more of the various embodiments. The phrase “in response to” (or equally “in response at least to”) is indicative that the phrase following the phrase “in response to” is an example of one of a multitude of suitable possibilities that may, or may not, be employed to one or more of the various embodiments. The phrase “depending on” (or equally “depending at least to”) is indicative that the phrase following the phrase “depending on” is an example of one of a multitude of suitable possibilities that may, or may not, be employed to one or more of the various embodiments. The phrase “employing/using” (or equally “employing/using at least”) is indicative that the phrase following the phrase “employing/using” is an example of one of a multitude of suitable possibilities that may, or may not, be employed to one or more of the various embodiments.

The term configured may relate to the capacity of a device whether the device is in an operational or non-operational state. Configured may refer to specific settings in a device that effect the operational characteristics of the device whether the device is in an operational or non-operational state. In other words, the hardware, software, firmware, registers, memory values, and/or the like may be “configured” within a device, whether the device is in an operational or nonoperational state, to provide the device with specific characteristics. Terms such as “a control message to cause in a device” may mean that a control message has parameters that may be used to configure specific characteristics or may be used to implement certain actions in the device, whether the device is in an operational or non-operational state.

In this disclosure, parameters (or equally called, fields, or Information elements: IEs) may comprise one or more information objects, and an information object may comprise one or more other objects. For example, if parameter (IE) N comprises parameter (IE) M, and parameter (IE) M comprises parameter (IE) K, and parameter (IE) K comprises parameter (information element) J. Then, for example, N comprises K, and N comprises J. In an example embodiment, when one or more messages/frames comprise a plurality of parameters, it implies that a parameter in the plurality of parameters is in at least one of the one or more messages/frames but does not have to be in each of the one or more messages/frames.

Many features presented are described as being optional through the use of “may” or the use of parentheses. For the sake of brevity and legibility, the present disclosure does not explicitly recite each and every permutation that may be obtained by choosing from the set of optional features. The present disclosure is to be interpreted as explicitly disclosing all such permutations. For example, a system described as having three optional features may be embodied in seven ways, namely with just one of the three possible features, with any two of the three possible features or with three of the three possible features.

Many of the elements described in the disclosed embodiments may be implemented as modules. A module is defined here as an element that performs a defined function and has a defined interface to other elements. The modules described in this disclosure may be implemented in hardware, software in combination with hardware, firmware, wetware (e.g. hardware with a biological element) or a combination thereof, which may be behaviorally equivalent. For example, modules may be implemented as a software routine written in a computer language configured to be executed by a hardware machine (such as C, C++, Fortran, Java, Basic, Matlab or the like) or a modeling/simulation program such as Simulink, Stateflow, GNU Octave, or LabVIEWMathScript. It may be possible to implement modules using physical hardware that incorporates discrete or programmable analog, digital and/or quantum hardware. Examples of programmable hardware comprise: computers, microcontrollers, microprocessors, application-specific integrated circuits (ASICs); field programmable gate arrays (FPGAs); and complex programmable logic devices (CPLDs). Computers, microcontrollers and microprocessors are programmed using languages such as assembly, C, C++ or the like. FPGAs, ASICs and CPLDs are often programmed using hardware description languages (HDL) such as VHSIC hardware description language (VHDL) or Verilog that configure connections between internal hardware modules with lesser functionality on a programmable device. The mentioned technologies are often used in combination to achieve the result of a functional module.

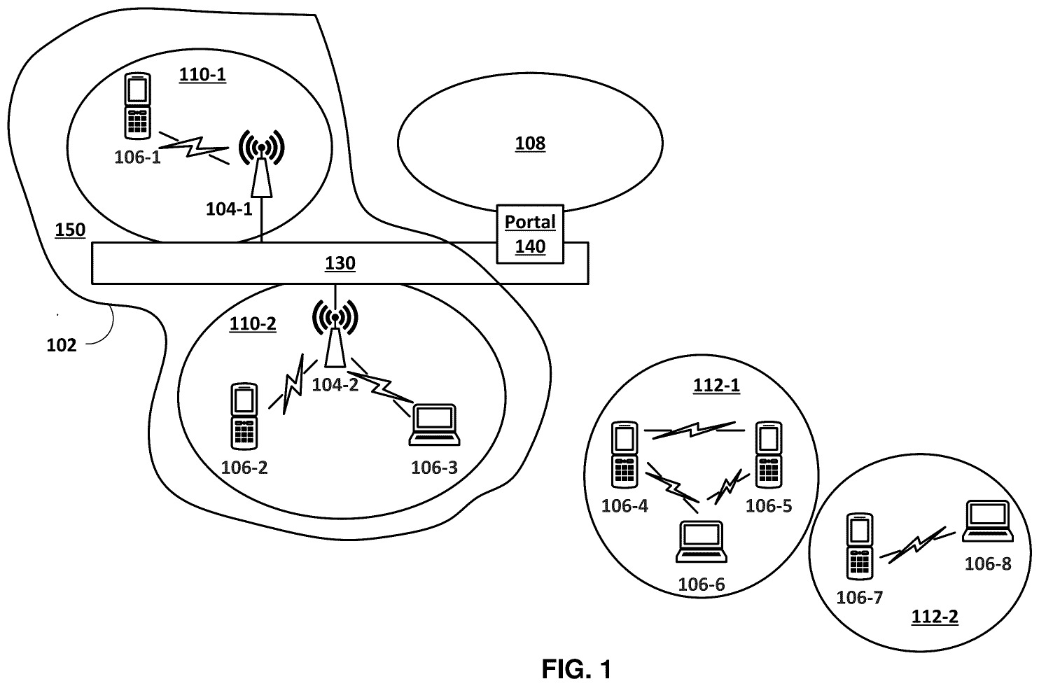

FIG. 1 illustrates example wireless communication networks in which embodiments of the present disclosure may be implemented.

As shown in FIG. 1, the example wireless communication networks may include an Institute of Electrical and Electronic Engineers (IEEE) 802.11 (WLAN) infra-structure network 102. WLAN infra-structure network 102 may include one or more basic service sets (BSSs) 110 and 120 and a distribution system (DS) 130.

BSS 110-1 and 110-2 each includes a set of an access point (AP or AP STA) and at least one station (STA or non-AP STA). For example, BSS 110-1 includes an AP 104-1 and a STA 106-1, and BSS 110-2 includes an AP 104-2 and STAs 106-2 and 106-3. The AP and the at least one STA in a BSS perform an association procedure to communicate with each other.

DS 130 may be configured to connect BSS 110-1 and BSS 110-2. As such, DS 130 may enable an extended service set (ESS) 150. Within ESS 150, APs 104-1 and 104-2 are connected via DS 130 and may have the same service set identification (SSID).

WLAN infra-structure network 102 may be coupled to one or more external networks. For example, as shown in FIG. 1, WLAN infra-structure network 102 may be connected to another network 108 (e.g., 802.X) via a portal 140. Portal 140 may function as a bridge connecting DS 130 of WLAN infra-structure network 102 with the other network 108.

The example wireless communication networks illustrated in FIG. 1 may further include one or more ad-hoc networks or independent BSSs (IBSSs). An ad-hoc network or IBSS is a network that includes a plurality of STAs that are within communication range of each other. The plurality of STAs are configured so that they may communicate with each other using direct peer-to-peer communication (i.e., not via an AP).

For example, in FIG. 1, STAs 106-4, 106-5, and 106-6 may be configured to form a first IBSS 112-1. Similarly, STAs 106-7 and 106-8 may be configured to form a second IBSS 112-2. Since an IBSS does not include an AP, it does not include a centralized management entity. Rather, STAs within an IBSS are managed in a distributed manner. STAs forming an IBSS may be fixed or mobile.

A STA as a predetermined functional medium may include a medium access control (MAC) layer that complies with an IEEE 802.11 standard. A physical layer interface for a radio medium may be used among the APs and the non-AP stations (STAs). The STA may also be referred to using various other terms, including mobile terminal, wireless device, wireless transmit/receive unit (WTRU), user equipment (UE), mobile station (MS), mobile subscriber unit, or user. For example, the term “user” may be used to denote a STA participating in uplink Multi-user Multiple Input, Multiple Output (MU MIMO) and/or uplink Orthogonal Frequency Division Multiple Access (OF DMA) transmission.

A physical layer (PHY) protocol data unit (PPDU) may be a composite structure that includes a PHY preamble and a payload in the form of a PHY service data unit (PSDU). For example, the PSDU may include a PHY preamble and header and/or one or more MAC protocol data units (MPDUs). The information provided in the PHY preamble may be used by a receiving device to decode the subsequent data in the PSDU. In instances in which PPDUs are transmitted over a bonded channel (channel formed through channel bonding), the preamble fields may be duplicated and transmitted in each of the multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is based on the particular IEEE 802.11 protocol to be used to transmit the payload.

A frequency band may include one or more sub-bands or frequency channels. For example, PPDUs conforming to the IEEE 802.11n, 802.11ac, 802.11ax and/or 802.11be standard amendments may be transmitted over the 2.4 GHz, 5 GHz, and/or 6 GHz bands, each of which may be divided into multiple 20 MHz channels. The PPDUs may be transmitted over a physical channel having a minimum bandwidth of 20 MHz. Larger channels may be formed through channel bonding. For example, PPDUs may be transmitted over physical channels having bandwidths of 40 MHz, 80 MHz, 160 MHz, or 320 MHz by bonding together multiple 20 MHz channels.

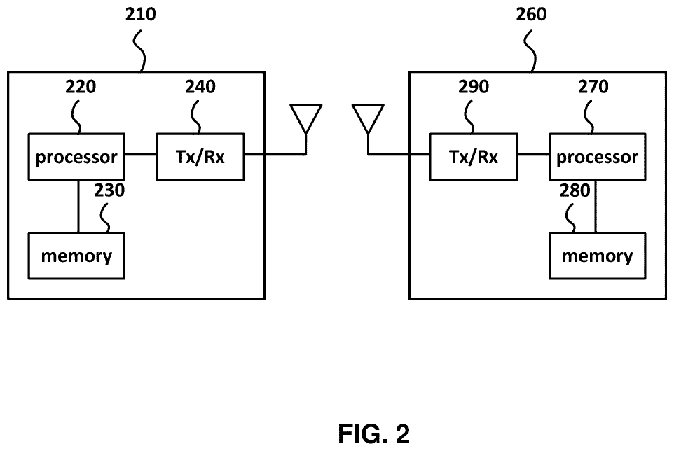

FIG. 2 is a block diagram illustrating example implementations of a STA 210 and an AP 260. As shown in FIG. 2, STA 210 may include at least one processor 220, a memory 230, and at least one transceiver 240. AP 260 may include at least one processor 270, memory 280, and at least one transceiver 290. Processor 220/270 may be operatively connected to transceiver 240/290.

Transceiver 240/290 may be configured to transmit/receive radio signals. In an embodiment, transceiver 240/290 may implement a PHY layer of the corresponding device (STA 210 or AP 260).

In an embodiment, STA 210 and/or AP 260 may be a multi-link device (MLD), that is a device capable of operating over multiple links as defined by the IEEE 802.11be standard amendment. As such, STA 210 and/or AP 260 may each have multiple PHY layers. The multiple PHY layers may be implemented using one or more of transceivers 240/290.

Processor 220/270 may implement functions of the PHY layer, the MAC layer, and/or the logical link control (LLC) layer of the corresponding device (STA 210 or AP 260).

Processor 220/270 and/or transceiver 240/290 may include application specific integrated circuit (ASIC), other chipset, logic circuit and/or data processor. Memory 230/280 may include read-only memory (ROM), random access memory (RAM), flash memory, memory card, storage medium and/or other storage unit.

When the embodiments are executed by software, the techniques (or methods) described herein can be executed with modules (e.g., processes, functions, and so on) that perform the functions described herein. The modules can be stored in memory 230/280 and executed by processor 220/270. Memory 230/280 may be implemented (or positioned) within processor 220/270 or external to processor 220/270. Memory 230/280 may be operatively connected to processor 220/270 via various means known in the art.

Target wake time (TWT), a feature introduced in the IEEE 802.11ah standard, allows STAs to manage activity in the BSS by scheduling STAs to operate at different times to reduce contention. TWTs may allow STAs to reduce the required amount of time that a STA utilizing a power management mode may be awake. TWTs may be individual TWTs or broadcast TWTs. Individual TWTs follow a negotiated TWT agreement between STAs. Broadcast TWTs are based on a schedule set and provided to STAs by an AP.

In an individual TWT, a STA that requests a TWT agreement is called a TWT requesting STA. The TWT requesting STA may be a non-AP STA for example. The STA that responds to the request is called a TWT responding STA. The TWT responding STA may be an AP for example. The TWT requesting STA is assigned specific times to wake up and exchange frames with the TWT responding STA. The TWT requesting STA may communicate wake scheduling information to the TWT responding STA. The TWT responding STA may transmit TWT values to the TWT requesting STA when a TWT agreement is established between them.

When explicit TWT is employed, the TWT requesting STA may wake up and perform a frame exchange. The TWT requesting STA may receive a next TWT information in a response from the TWT responding STA. When implicit TWT is used, the TWT requesting STA may calculate a next TWT by adding a fixed value to the current TWT value.

The TWT values for implicit TWT may be periodic. The TWT requesting STA operating with an implicit TWT agreement may determine a next TWT service period (TWT SP) start time by adding a value of a TWT wake interval associated with the TWT agreement to the value of the start time of the current TWT SP. The TWT responding STA may include the start time for a series of TWT SPs corresponding to a single TWT flow identifier of an implicit TWT agreement in a target wake time field of a TWT element. The TWT element may contain a value of ‘accept TWT’ in a TWT setup command field. The start time of the TWT SP series may indicate the start time of a first TWT SP in the series. Start times of subsequent TWT SPs may be determined by adding the value of the TWT wake interval to the start time of the current TWT SP. In an example, the TWT requesting STA, awake for an implicit TWT SP, may enter doze state after the TWT SP has elapsed or after receiving an end of service period (EOSP) field equal to 1 from the TWT responding STA, whichever occurs first.

A TWT session may be negotiated between an AP and a STA. The TWT session may configure a TWT SP of DL and UL traffic between the AP and the STA. Expected traffic may be limited within the negotiated SP. The TWT SP may start at a specific time. The TWT SP may run for a SP duration. The TWT SP may repeat every SP interval.

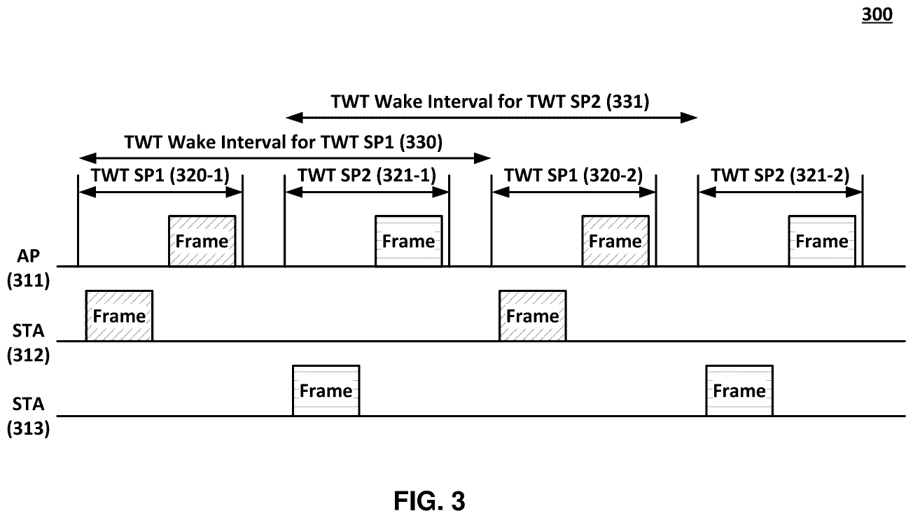

FIG. 3 illustrates an example 300 of TWT operation. As shown in FIG. 3, example 300 includes an AP 311, a STA 312, and a STA 313. AP 311 and STA 312 may establish a TWT SP 320. AP 311 and STA 313 may establish a TWT SP 321. TWT SP 320 and TWT SP 321 may repeat as shown in FIG. 3, such that TWT SP 320 may include a first TWT SP 320-1 and a second TWT SP 320-2, and such that TWT SP 321 may include a first TWT SP 321-1 and a second TWT SP 321-2.

AP 311 and STA 312 may exchange frames during first TWT SP 320-1. STA 312 may enter a doze state at the end of TWT SP 320-1 and may remain in the doze state until the start of second TWT SP 320-2. The start of second TWT SP 320-2 may be indicated by a TWT wake interval 330 associated with TWT SP 320. AP 311 and STA 312 may again exchange frames during second TWT SP 320-2.

Similarly, AP 311 and STA 313 may exchange frames during first TWT SP 321-1. STA 313 may enter a doze state at the end of first TWT SP 321-1 and may remain in the doze state until the start of second TWT SP 321-2. The start of second TWT SP 321-2 may be indicated by a TWT wake interval 331 associated with TWT SP 321. AP 311 and STA 313 may again exchange frames during second TWT SP 31-2.

In an awake state, a STA may be fully powered. The STA may transmit and/or receive a frame to/from an AP or another STA. In a doze state, a STA may not transmit and may not receive a frame to/from an AP or another STA.

An MLD is an entity capable of managing communication over multiple links. The MLD may be a logical entity and may have more than one affiliated station (STA). The MLD may have a single MAC service access point (MAC-SAP) to the LLC layer, which includes a MAC data service. An MLD may be an access point MLD (AP MLD) when a STA affiliated with the MLD is an AP STA (or an AP). An MLD may be a non-access point MLD (non-AP MLD) when a STA affiliated with the MLD is a non-AP STA (or a STA).

During negotiation of TWT agreements, a TWT requesting STA affiliated with a STA MLD and a TWT responding STA affiliated with an AP MLD may communicate multiple TWT elements. The TWT elements may comprise link ID bitmap subfields indicating different link(s) in a TWT setup frame. The TWT parameters provided by a TWT element may be applied to the respective link that is indicated in the TWT element.

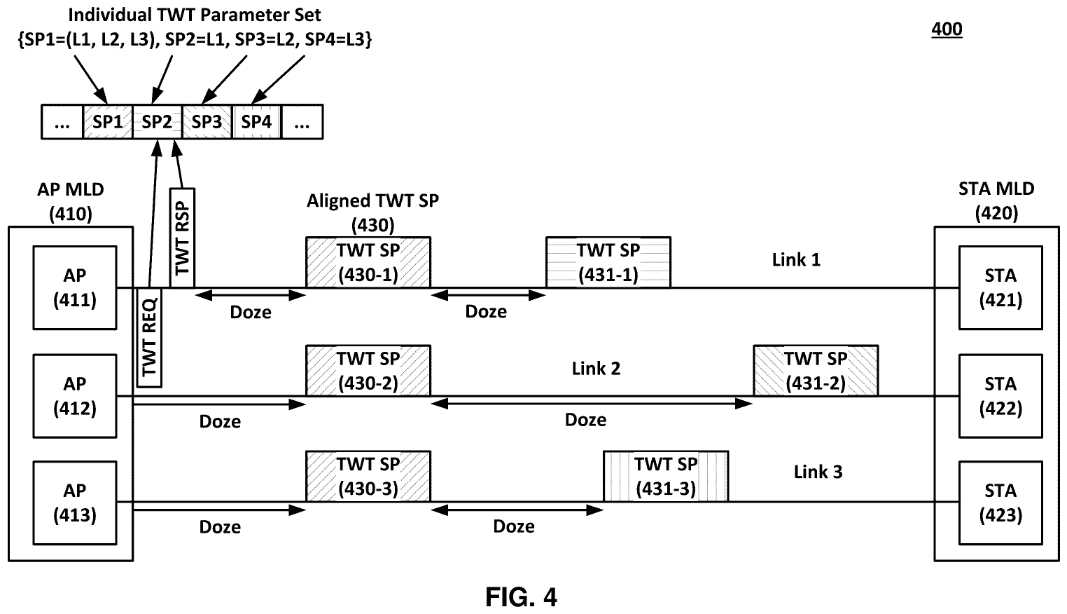

FIG. 4 illustrates an example 400 of TWT operation in a multi-link environment including an AP multi-link device (AP MLD) 410 and a STA multi-link device (STA MLD) 420. As shown in FIG. 4, AP MLD 410 may have three affiliated APs, AP 411, AP2 412, and AP3 413. In an example, AP 411, AP2 412, and AP3 413 may operate respectively on the 2.4 GHz band, the 5 GHz band, and the 6 GHz band. STA MLD 420 may have three affiliated STAs, STA 421, STA 422, and STA 423. In an example, STA 421, STA 422, and STA 423 may operate respectively on the 2.4 GHz band, the 5 GHz band, and the 6 GHz band. In an example, AP 411, AP2 412, and AP3 413 may be communicatively coupled via a first link (link 1), a second link (link 2), and a third link (link 3) respectively with STA 421, STA 422, and STA 423, respectively.

In an example, STA 421 may transmit a TWT request to AP 411. The TWT request may include three TWT elements. Each TWT element may indicate a respective link of links 1-3 and may request the setup of a TWT agreement for the indicated link. The three TWT elements may have different TWT parameters, such as target wake time (TWT). In response to the TWT request, AP 411 may transmit a TWT response to STA 421. The TWT response may include three TWT elements. Each TWT element may indicate a respective link of links 1-3 and may include a value of ‘accept TWT’ in a TWT setup command field.

Successful TWT agreement setup on links 1-3 establishes three TWT SPs with same or different TWT parameters on links 1-3 respectively. The target wake time field of the TWT element indicating a given link indicates the start time of the TWP SP for that link. The starting time may be indicated in reference to a time synchronization function (TSF) time of the link.

In example 400, initial TWT SPs 430-1, 430-2, and 430-3 of links 1-3 respectively may be aligned. TWT wake intervals associated with the TWT agreements of links 1-3 respectively may be set differently. As such, second TWT SPs 431-1, 431-2, and 431-3 of links 1-3 respectively may not be aligned. STA 421, STA 422, and STA 423 may enter a doze state between the end of initial TWT SPs 430-1, 430-2, and 430-3, respectively, and the start of second TWT SPs 431-1, 431-2, 431-3, respectively.

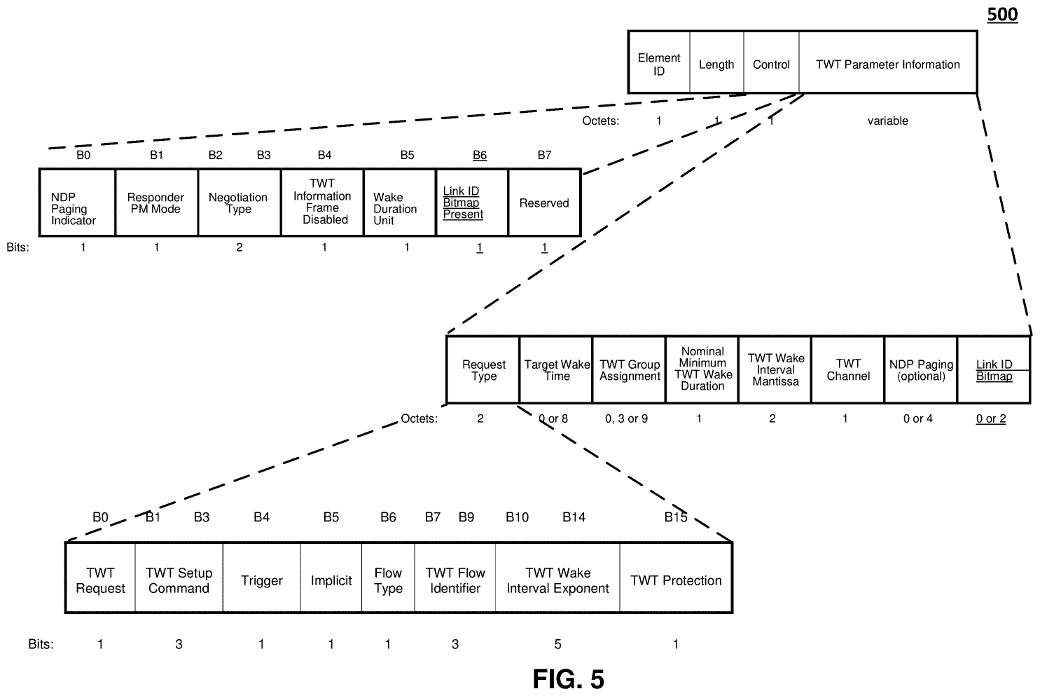

FIG. 5 illustrates an example target wake time (TWT) element 500 which may be used to support individual TWT operation.

In an example, an AP and a STA may use TWT element 500 to negotiate a TWT agreement. The AP and/or the STA may transmit TWT element 500 in an individually addressed management frame. The management frame may be of the type action, action no ack, (re)association request/response, and probe request response, for example.

The TWT schedule and parameters may be provided during a TWT setup phase. Renegotiation/changes of TWT schedules may be signaled via individually addressed frames that contain the updated TWT schedule/parameters. The frames may be management frames as described above or control or data frames that carry a field containing the updated TWT schedule/parameters.

Referring to FIG. 5, TWT element 500 includes an element ID field, a length field, a control field, and a TWT parameter information field.

The element ID field (e.g., 1 octet in length) may indicate that information element 500 is a TWT element. The length field (e.g., 1 octet) may indicate the length of TWT element 500 starting from the control field until an end of TWT element 500. The end of TWT element 500 may be the end of a TWT Channel field or the end of a Link ID bitmap field of the TWT parameter information field.

The TWT parameter information field may include a request type field (e.g., 2 octets), a target wake time field (e.g., 8 octets or less), a TWT group assignment field (e.g., 9, 3, 2, or 0 octets), a nominal minimal TWT wake duration field (e.g., 1 octet), a TWT wake interval mantissa (e.g., 2 octets), a TWT channel field (e.g., 1 octet), an optional NDP paging field (e.g., 0 or 4 octets), and/or a Link ID bitmaps field (e.g., 0 or 2 Octets).

The request type field may indicate a type of TWT request. The request type field may include a TWT request field (e.g., 1 bit), a TWT setup command field (e.g., 3 bits), a trigger field (e.g., 1 bit), an implicit field (e.g., 1 bit), a flow type (e.g., 1 bit), a TWT flow identifier (e.g., 3 bits), a TWT wake interval exponent (e.g., 5 bits), and/or a TWT protection field (e.g., 1 bit).

The TWT request field may indicate whether the TWT element 500 represents a request. If TWT request field has a value of 1, then the TWT element 500 may represent a request to initiate TWT scheduling/setup.

The TWT setup command field may indicate a type of TWT command. In a TWT request, the type of TWT command indicated may be: a request TWT (the TWT responding STA specifies the TWT value; e.g., field set to 0), a suggest TWT (the TWT requesting STA suggests a TWT value; e.g., field set to 1), and a demand TWT (the TWT requesting STA demands a TWT value; e.g., field set to 2).

In a TWT response, the type of TWT command indicated may be: TWT grouping (the TWT responding STA suggests TWT group parameters that are different than the suggested or demanded TWT parameters of the TWT requesting STA; e.g., field set to 3), accept TWT (the TWT responding STA accepts the TWT request with the TWT parameters indicated by the TWT requesting STA; e.g. field set to 4), alternate TWT (the TWT responding STA suggests TWT parameters that are different than the parameters suggested or demanded by the TWT requesting STA; e.g., field set to 5), dictate TWT (the TWT responding STA demands TWT parameters that are different than the parameters suggested or demanded by the TWT requesting STA; e.g., field set to 6), or reject TWT (the TWT responding STA rejects the TWT setup; e.g. field set to 7).

In a TWT response, the TWT command may also indicate an unsolicited response or a broadcast TWT. An unsolicited TWT response is an individually addressed frame that is intended for a specific STA. An unsolicited TWT response may be followed by an ACK frame from the STA receiving the unsolicited TWT response. A broadcast TWT may be intended for multiple STAs and may be carried in a broadcast frame such as, for example, a beacon frame. A broadcast TWT may not be acknowledged by receiving STAs.

An unsolicited TWT response may be used a TWT responding STA to demand that a recipient follow a TWT schedule contained in the TWT element. In an embodiment, an unsolicited TWT response may have the TWT request field set to 0 and a value of ‘dictate TWT’ in the TWT setup command field. A broadcast TWT response may be used by a TWT responding STA to schedule a TWT for any STA that receives and decodes the TWT element.

In certain embodiments, a TWT element, such as TWT element 500, may contain TWT parameter sets for multiple TWT negotiations or indications as described herein. As such, the TWT element may include multiple instances of the Control and the TWT parameter information fields. The TWT flow identifier of the request type field indicates the TWT negotiation which parameters are carried by the TWT parameter information field.

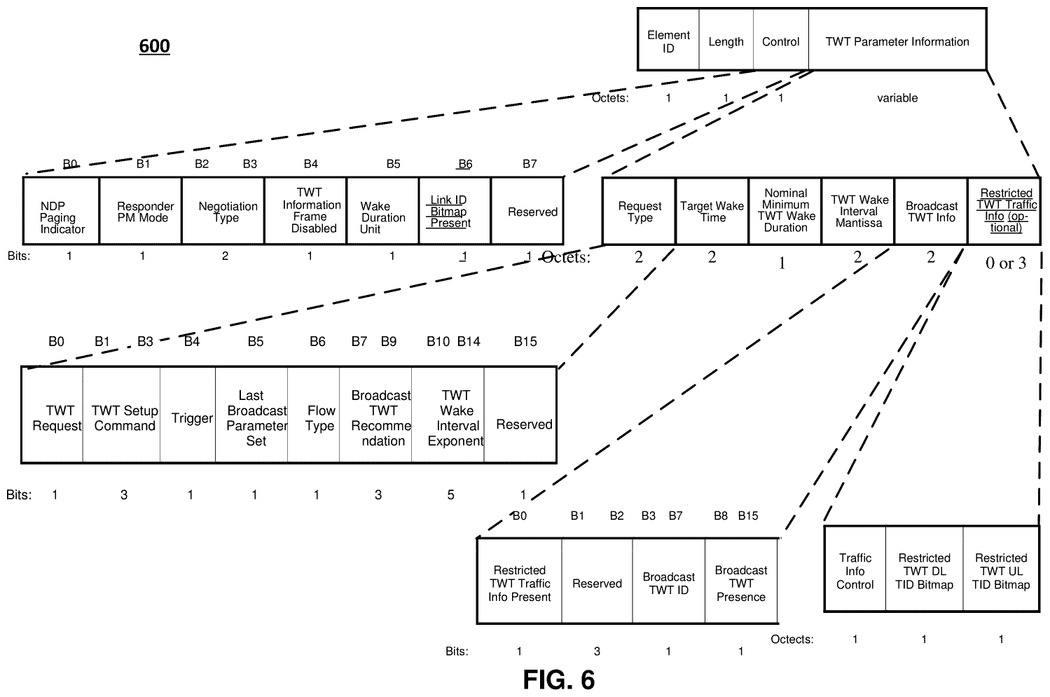

FIG. 6 illustrates an example target wake time (TWT) element 600 which may be used to support restricted TWT operation. For restricted TWT, TWT element 600 may be transmitted in a broadcast management frame, which can be a beacon frame, a TIM broadcast frame, a probe response frame, etc. In this embodiment, TWT element 600 provides non-negotiated TWT schedules (e.g., broadcast TWT schedules).

As shown, TWT element 600 includes an element ID field, a length field, a control field, and a TWT parameter information field.

The element ID field (e.g., 1 octet in length) may indicate that information element 600 is a TWT element. The length field (e.g., 1 octet) may indicate the length of TWT element 600 starting from the control field until an end of TWT element 600. The end of TWT element 600 may be the end of a broadcast TWT info field or the end of a restricted TWT traffic info field of the TWT parameter information field.

The TWT parameter information field may include a request type field, a target wake time field (e.g., 2 octets), a nominal minimal TWT wake duration field (e.g., 1 octet), a TWT wake interval mantissa (e.g., 2 octets), a broadcast TWT info field (e.g., 2 octets), and an optional restricted TWT traffic info field (e.g., 0 or 3 octets).

The request type field may include, among other fields, a TWT request field, a flow type field, and a TWT wake interval exponent field.

The TWT request field indicates whether TWT element 600 is a request. If the TWT request field has a value of 0, then TWT element 600 may represent a response to a request to initiate TWT scheduling/setup (solicit TWT), an unsolicited TWT response, and/or a broadcast TWT message.

The TWT wake interval represents the average time that a TWT requesting STA or a TWT scheduled STA expects to elapse between successive TWT SP start times of a TWT schedule. The TWT wake interval exponent field indicates a (base 2) exponent used to calculate the TWT wake interval in microseconds. In an embodiment, the TWT wake interval is equal to: (TWT wake interval mantissa)×2^{(TWT Wake Interval Exponent)}, The TWT wake interval mantissa value is indicated in microseconds, base 2 in a TWT wake interval mantissa field of the TWT parameter information field.

The nominal minimum TWT wake duration field may indicate the minimum amount of time (in the unit indicated by a wake duration unit subfield of the control field) that a TWT requesting STA or a TWT scheduled STA is expected to be awake to complete frame exchanges for the period of the TWT wake interval.

The flow type field, in a TWT response that successfully set up a TWT agreement between a TWT requesting STA and a TWT responding STA, may indicate a type of interaction between the TWT requesting STA and the TWT responding STA within a TWT SP of the TWT agreement. A flow type field equal to 0 may indicate an announced TWT. In an announced TWT, the TWT responding STA may not transmit a frame to the TWT requesting STA within a TWT SP until the TWT responding STA receives a PS-Poll frame or a QoS Null frame from the TWT requesting STA. A flow type field equal to 1 may indicate an unannounced TWT. In an unannounced TWT, the TWT responding STA may transmit a frame to the TWT requesting STA within a TWT SP before it has received a frame from the TWT requesting STA.

Within a TWT element that includes a TWT setup command value of ‘request TWT’, ‘suggest TWT’, or ‘demand TWT’, a broadcast TWT ID may indicate a specific broadcast TWT in which the TWT requesting STA is requesting to participate. Within a TWT element that includes a TWT setup command value of ‘accept TWT’, ‘alternate TWT’, ‘dictate TWT’, or ‘reject TWT’, a broadcast TWT ID may indicate a specific broadcast TWT for which the TWT responding STA is providing TWT parameters. The value 0 in the broadcast TWT ID subfield may indicate the broadcast TWT whose membership corresponds to all STAs that are members of the BSS corresponding to the BSSID of the management frame carrying the TWT element and that is permitted to contain trigger frames with random access resource units for unassociated STAs. The Broadcast TWT ID subfield in a restricted TWT Parameter set field is always set to a nonzero value.

A broadcast TWT element 600 that contains a restricted TWT parameter set is also referred to as a restricted TWT element. A restricted TWT traffic info present subfield of the broadcast TWT info field may be set to 1 to indicate the presence of the restricted TWT traffic info field in TWT element 600. The restricted TWT traffic info field is present in a restricted TWT parameter set field when the restricted TWT traffic info present subfield is set to 1.

The restricted TWT traffic info field may include a traffic info control field, a restricted TWT DL TID bitmap field, and a restricted TWT UL TID bitmap field.

The traffic info control field may include a DL TID bitmap valid subfield and an UL TID bitmap valid subfield. The DL TID bitmap valid subfield indicates if the restricted TWT DL TID bitmap field has valid information. When the value of the DL TID bitmap valid subfield is set to 0, it may indicate that DL traffic of TIDs is identified as latency sensitive traffic, and the restricted TWT DL TID bitmap field is reserved. The UL TID bitmap valid subfield may indicate if the restricted TWT UL TID bitmap field has valid information. When the value of the UL TID bitmap valid subfield is set to 0, it may indicate that UL traffic of TIDs is identified as latency sensitive traffic, and the restricted TWT UL TID bitmap field is reserved.

The restricted TWT DL TID bitmap subfield and the restricted TWT UL TID bitmap subfield may specify which traffic identifiers (TIDs) are identified by the TWT scheduling AP or the TWT scheduled STA as latency sensitive traffic streams in a downlink and a uplink direction, respectively. A value of 1 at bit position kin the bitmap indicates that TID k is classified as a latency sensitive traffic stream. A value of 0 at bit position kin the bitmap indicates that TID k is not classified as a latency sensitive traffic stream.

An individual target wake time (TWT) may be a specific time or set of times negotiated between two individual stations (e.g., a STA and another STA, or a STA and an AP, etc.) at which the stations may be awake to exchange frames during a service period (SP) of the TWT.

In trigger-enabled TWT, an AP may transmit a trigger frame for scheduling uplink multi-user transmissions from one or more STAs using uplink OFDMA (orthogonal frequency division multiple access) and/or uplink MU-MIMO (multi-user multiple input multiple output) during a trigger-enabled TWT SP. A TWT STA that receives the trigger frame from the AP may transmit a frame to the AP through a resource indicated in the trigger frame during the trigger-enabled TWT SP.

In non-trigger-enabled TWT, an AP may not be required to transmit a trigger frame to schedule uplink multi-user transmissions from one or more STAs during a non-trigger-enabled TWT SP.

In announced TWT, a STA may transmit a frame (e.g., a PS-Poll frame or a QoS null frame) to the AP to retrieve a downlink buffered data from the AP during a TWT SP. In unannounced TWT, an AP may transmit downlink data to a TWT STA without receiving a frame (e.g., a PS-Poll frame, or a QoS null frame) from the TWT STA during a TWT SP.

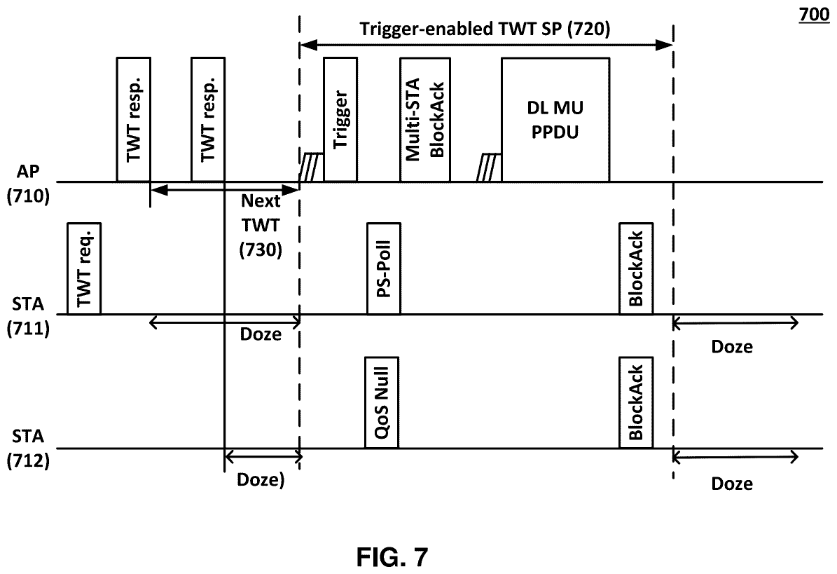

FIG. 7 illustrates an example 700 of individual TWT operation. As shown in FIG. 7, example 700 includes an AP 710, a first STA 711, and a second STA 712. In an example, AP 710 may be a TWT responding STA and STA 711 and STA 712 may be TWT requesting STAs.

In an example, STA 711 may transmit a TWT request to AP 710 to setup a first trigger-enabled TWT agreement. STA 711 may set a trigger field of the TWT request to 1 to indicate that it is requesting a trigger-enabled TWT. AP 710 may accept the first TWT agreement with STA 711. AP 710 may confirm the acceptance in a TWT response sent to STA 711. The TWT response may indicate a next TWT 730, which indicates the time until a next TWT SP 720 according to the first TWT agreement.

In an example, AP 710 may transmit an unsolicited TWT response to STA 712 to set up a second trigger-enabled TWT agreement with STA 712 without receiving a TWT request from STA 712. The first and second TWT agreements may be set up as announced TWTs.

After the setup of the TWT agreements, STA 711 and STA 712 may enter a doze state until the start of TWT SP 720. During trigger-enabled TWT SP 720, AP 710 may transmit a trigger frame. STA 711 and STA 12 may respond to the trigger frame by indicating that they are in awake state. In an example, STA 711 may transmit a power save poll (PS-Poll) frame. The PS-Poll frame may comprise a BSSID (receiver address: RA) field set to an address of AP 710 and a transmitter address (TA) field set to an address of STA 711. In an example, STA 712 may transmit a QoS null frame in response to the trigger frame. The QoS null frame may comprise a MAC header (e.g., a frame control field, a duration field, address fields, a sequence control field, QoS control field) without a frame body.

In response to the PS-Poll frame and the QoS null frame, AP 710 may transmit a multi-STA BlockAck (M-BA) frame. The M-BA frame may include acknowledgement information associated with the PS-Poll frame and the QoS null frame received from STAs 711 and 712 respectively. Subsequently, STA 711 and STA 712 may receive downlink bufferable units (DL BUs) from AP 710. The DL BUs may include a medium access control (MAC) service data unit (MSDU), an aggregate MAC service data unit (A-MSDU), and/or a bufferable MAC management protocol data unit (MMPDU). STA 711 and STA 712 may transmit BlockAck (BA) frames in response to the DL BUs. At the end of the TWT SP 720, STA 711 and STA 712 may return to a doze state.

A STA may execute individual TWT setup exchanges. The STA may not transmit frames to an AP outside of negotiated TWT SPs. The STA may not transmit frames that are not contained within high efficiency trigger-based physical protocol data units (HE TB PPDUs) to the AP within trigger-enabled TWT SPs. A HE TB PPDU may be transmitted by a STA based on receiving a trigger frame triggering uplink multi-user transmissions.

The AP of a trigger-enabled TWT agreement may schedule for transmission a trigger frame for a STA within the trigger-enabled TWT SP. The STA may transmit an HE TB PPDU as a response to the trigger frame sent during the trigger-enabled TWT SP. A STA that is in power save (PS) mode may include a PS-Poll frame or a QoS null frame in the HE TB PPDU if the TWT is an announced TWT, to indicate to the AP that the STA is currently in the awake state. The AP that receives the PS-Poll frame or the QoS Null frame or any other indication from a STA in PS mode, may deliver to the STA as many buffered BUs as are available at the AP during the TWT SP.

A broadcast target wake time (TWT) may be a specific time or set of times broadcast by an AP to one or more STAs at which the STAs may be awake to exchange frames with the AP during a SP of the TWT.

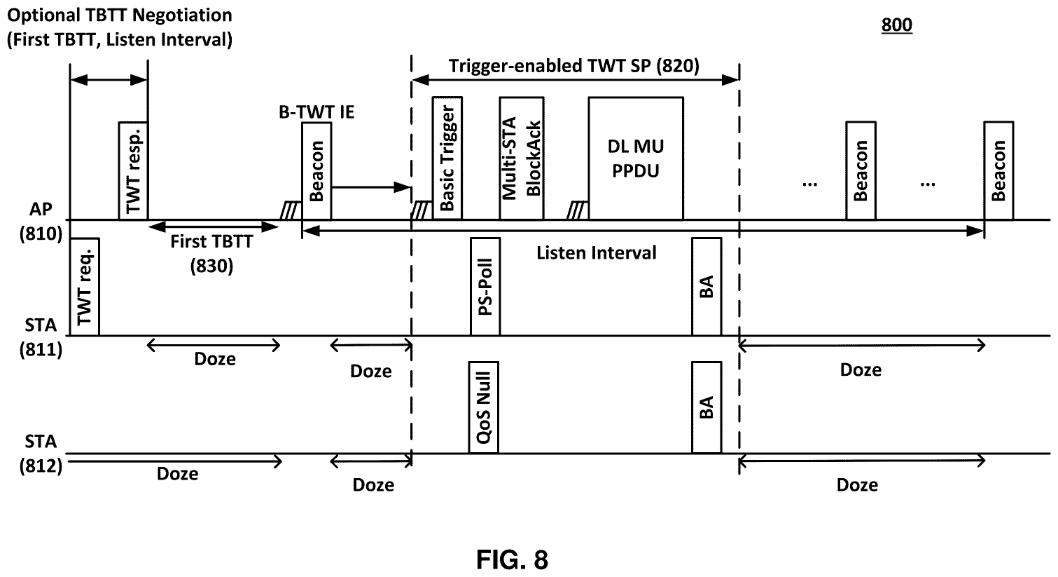

FIG. 8 illustrates an example 800 of broadcast TWT operation. As shown in FIG. 8, example 800 includes an AP 810, a first STA 811, and a second STA 812. In an example 800, AP 810 may be a TWT scheduling AP and STA 811 and STA 812 may be TWT scheduled STAs.

In an example, AP 810 may include a broadcast TWT element in a beacon frame that indicates a broadcast TWT SP 820. During the broadcast TWT SP 820, AP 810 may transmit trigger frames or DL BUs to STA 811 and STA 812. Beacon frames may be sent by AP 810 at a regular interval defined as the target beacon transmission time (TBTT). The TBTT is a time interval measured in time units (TUs). A TU is equal to 1024 microseconds.

In an example, STA 811 and STA 812 may enter a doze state until the first target beacon transmission time (TBTT). STA 811 and STA 812 may wake up to receive the beacon frame at the first TBTT to determine the broadcast TWT. Upon reception of a broadcast TWT element in a beacon frame, STA 811 and STA 812 may re-enter the doze state until the start of trigger-enabled TWT SP 820.

During trigger-enabled TWT SP 820, AP 810 may transmit a basic trigger frame to STA 811 and STA 812. STA 811 may indicate that it is awake by transmitting a PS-Poll, and STA 812 may indicate that it is awake by transmitting a QoS null frame in response to the basic trigger frame. Subsequently, STA 811 and STA 812 may receive DL BUs from AP 810. STA 811 and STA 812 may return to the doze state outside of the TWT SP 720.

In an example, a STA that intends to operate in power save mode may negotiate a wake TBTT and a wake interval with the AP. For example, as shown in FIG. 8, STA 811 may transmit a TWT request to AP 810 that identifies a wake TBTT of the first beacon frame and a wake interval between subsequent beacon frames. AP 810 may respond with a TWT response to the TWT request confirming the wake TBTT and wake interval. After successfully completing the negotiation, STA 811 may enter a doze state until a first negotiated wake TBTT 830. STA 811 may be in an awake state to listen to the beacon frame transmitted at first negotiated wake TBTT 830. If STA 811 receives a beacon frame from AP 810 at or after TBTT 830, STA 811 may return to the doze state until the next wake TBTT unless a traffic indication map (TIM) element in a beacon frame includes a positive indication for STA 811. The STA 811 may return to the doze state after a nominal minimum TBTT wake duration time has elapsed from the TBTT start time.

A Network Allocation Vector (NAV) is an indicator, maintained by a station (STA), of time periods when transmission onto the wireless medium (WM) may not be initiated by the STA regardless of whether the clear channel assessment (CCA) function of the STA senses that the WM is busy. A STA that receives at least one valid frame in a PSDU may update its NAV with the information from any valid duration field in the PSDU. The STA may update the NAV when a value of the received duration field is greater than the current NAV value of the STA.

A TWT protection is a mechanism employed to protect a TWT session from external STA transmissions. During a TWT SP configured to protect the TWT session, a STA that initiates a transmission opportunity (TXOP) to transmit a frame may transmit a request to transmit (RTS) frame or a clear to transmit (CTS) frame to protect the TWT session by setting the NAV of other STAs based on receiving of the RTS frame and/or the CTS frame. The RTS frame may comprise a frame control field, a duration field, a receiver address (RA) field, a transmitter address (TA) field, and a frame check sequence (FCS) field. The CTS frame may comprise a frame control field, a duration field, a receiver address (RA) field, and a frame check sequence (FCS) field.

The TWT protection field in a TWT element may indicate whether a TWT is protected or unprotected. A TWT requesting STA may set the TWT protection field to 1 to request the TWT responding STA to provide protection for the set of TWT SPs. A TWT protection field equal to 1 may indicate to use a NAV protection mechanism to protect access to the medium during the corresponding TWT SPs.

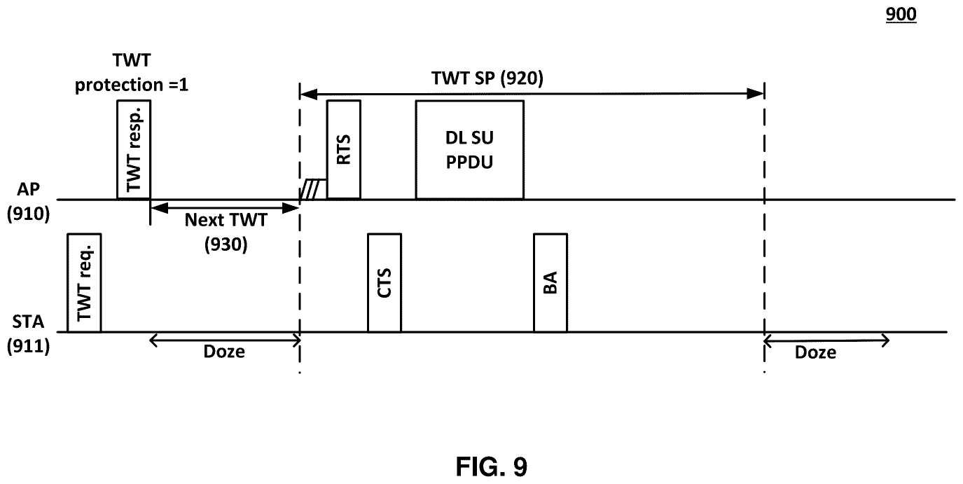

FIG. 9 illustrates an example 900 of TWT protection in individual TWT operation. As shown in FIG. 9, example 900 includes an AP 910 and a STA 911.

In an example, AP 910 may set the TWT protection field to 1 in a TWT response frame to protect the TWT SPs using a NAV protection mechanism. Upon reception of the TWT response frame, STA 911 may enter a doze state until the next TWT 930. AP 910 that has set the TWT protection field to 1 may transmit a NAV setting frame at the start of the TWT SP 920. For example, the NAV setting frame may be an RTS frame or a CTS frame.

A STA that receives the NV setting frame and that is not scheduled to access the medium during the TWT SP 920 may set their NAV according to the NAV setting frame. The STA may not access the medium for the specified amount of time in the NAV setting frame.

STA 911 may be scheduled to access the medium during the TWT SP 920. STA 911 may respond to the RTS frame with a CTS frame. Upon receiving the CTS frame, AP 910 may transmit a downlink frame to STA 911. STA 911 may respond to the downlink frame with a Block Ack frame. When the TWT SP 920 ends, STA 911 may return to the doze state.

Traffic originating from many real time applications may have stringent latency requirements (e.g., very low average latency, worst-case latency on the order of a few to tens of milliseconds, and small jitter). Such traffic is referred to as latency sensitive traffic. Restricted TWT operation may allow an AP to use enhanced medium access protection and resource reservation mechanisms to provide more predictable latency, reduced worst case latency, and/or reduced jitter, with higher reliability for latency sensitive traffic.

Using TWT, a STA may negotiate awake periods with an AP to transmit and receive data packets. The STA may save power the rest of the time as the STA may remain in a doze state. TWT operation may thus lead to low power consumption for the participating STAs. TWT operation may also reduce the contention level and may support a collision-free and deterministic operation when STAs are distributed over different TWT sessions.

Using restricted TWT (r-TWT) operation, an AP may allocate r-TWT SP(s) that may be used for transmission of data frames with latency sensitive traffic by the AP and one or more STAs. TIDs of latency sensitive traffic may be indicated in a broadcast frame (e.g., beacon frame, probe response frame, etc.) sent by the AP. The TIDs may be indicated in a restricted TWT DL TID bitmap and/or a restricted TWT UL TID bitmap of a restricted TWT traffic info field of a TWT element. A data frame with a TID that is not identified as latency sensitive traffic may not be transmitted during an r-TWT SP.

A restricted TWT scheduling AP, referred to as an r-TWT scheduling AP, may be an extremely high throughput AP (EHT AP) that supports restricted TWT operation. A restricted TWT scheduled STA, referred to as an r-TWT scheduled STA, is a non-AP EHT STA that supports r-TWT operation. When a restricted TWT agreement is set up, the EHT AP may announce a restricted TWT SP (r-TWT SP) schedule information in a broadcast TWT element. The broadcast TWT element may be contained in a management frame such as a beacon frame or a probe response frame.

The EHT AP may schedule a quiet interval that overlaps with a r-TWT SP. The quiet interval may have a duration of 1 TU. The quiet interval may start at the same time as the corresponding r-TWT SP. A quiet interval may be scheduled by including a quiet element in a beacon frame and/or a probe response frame. Legacy STAs may not be permitted to initiate a frame transmission during the quiet interval overlapping with the r-TWT SP.

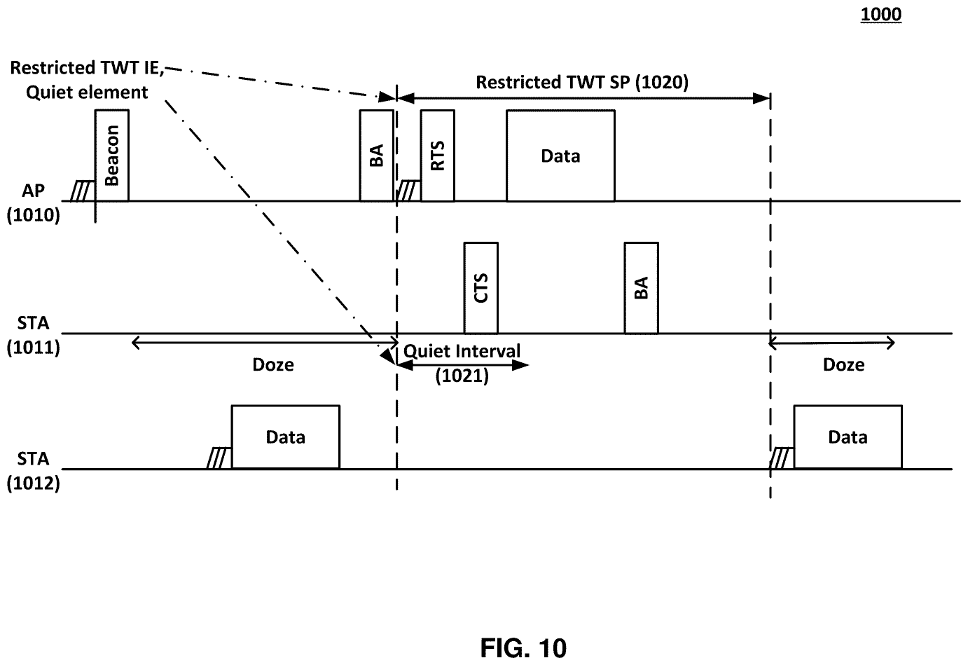

FIG. 10 illustrates an example 1000 of r-TWT operation. As shown in FIG. 10, example 1000 includes an AP 1010, a first STA 1011, and a second STA 1012.

In an example, a r-TWT agreement may be setup between AP 1010 and STA 1011. The r-TWT agreement may not include STA 1012. For example, STA 1012 may be a legacy STA or an EHT STA not scheduled by AP 1010 as part of the r-TWT agreement.

In an example, AP 1010 may transmit a beacon frame including a TWT element that indicates an r-TWT SP 1020 and TIDs allowed to be transmitted during the r-TWT SP 1020. The beacon frame may also include a quiet element indicating a quiet interval 1021.

Upon receiving the beacon frame, STA 1011 may enter a doze state and may remain in the doze state until the start of r-TWT SP 1020. STA 1012, which is not scheduled by AP 1010 for the r-TWT SP 1020, may transmit a data frame after receiving the beacon frame. However, STA 1012 must end its transmission before the start of r-TWT SP 1020.

During the r-TWT SP 1020, AP 1010 and STA 1011 may exchange an RTS frame and a CTS frame. Subsequently, AP 1010 may send a data frame to STA 1011. The data frame includes traffic having a TID from among the TIDs indicated as permitted to transmit during r-TWT SP 1020 (i.e., latency sensitive traffic) in the beacon frame. STA 1012 may not access the channel at least during quiet interval 1021 indicated in the beacon frame. When quiet interval 1021 or r-TWT SP 1020 ends, STA 1012 may resume its transmission. STA 1011 may enter doze state at the end of r-TWT SP 1020.

As discussed above, an r-TWT SP may be allocated to one or more AP STAs and non-AP STAs. But when a STA that is scheduled in the r-TWT SP does not use the r-TWT SP for transmission, radio resources of the r-TWT SP may be wasted. An r-TWT scheduled STA may not use the r-TWT SP in one or more of the following example situations:
the STA in power saving mode may not wake up to receive a beacon frame that includes a TWT element for the r-TWT SP;
the STA may fail to decode a beacon frame that includes a TWT element for the r-TWT SP;
the STA may not have any UL frame to transmit to the associated AP during the r-TWT SP.

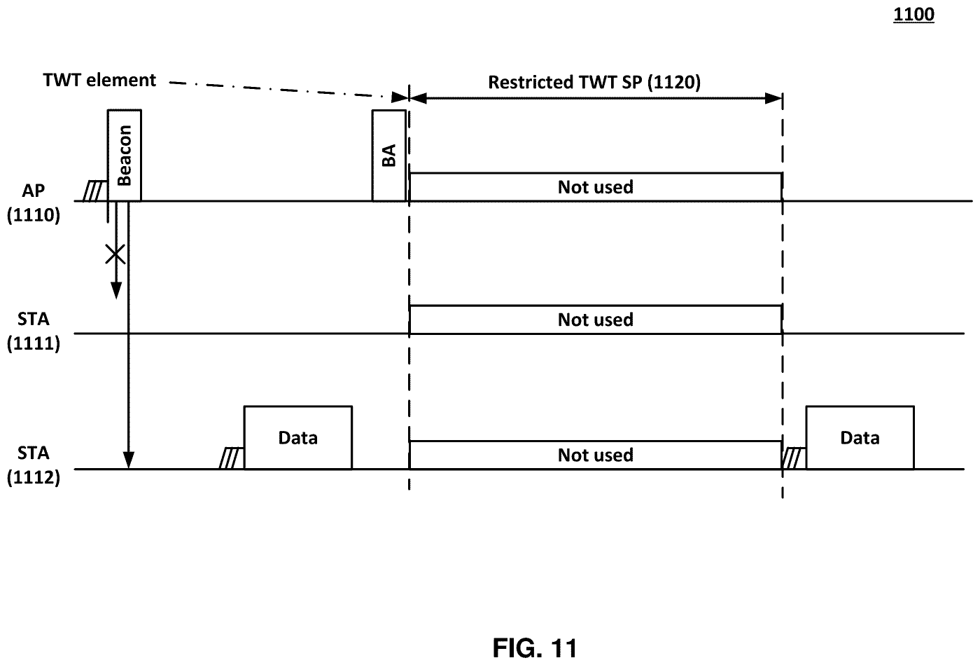

FIG. 11 illustrates an example 1100 of r-TWT operation according to existing technologies. As shown in FIG. 11, example 1100 includes an AP 1110, a first STA 1111, and a second STA 1112.

AP 1110 may transmit a beacon frame including a TWT element for allocating a r-TWT SP 1120 to STA 1111. In an example, STA 1111 may be in a power saving mode before the transmission of the beacon frame and may not wake up to receive the beacon frame. It is noted that a STA in power saving mode wakes up to receive beacon frames at least once within a listen interval of the STA. A legacy STA is not required to receive every beacon frame transmitted within the listen interval. A non-AP STA may miss beacon frames including a TWT element for an r-TWT SP. Due to being in power saving mode at the time of transmission of the beacon frame, STA 1111 does not learn of r-TWT SP 1120 indicated by the beacon frame and thus does not use r-TWT SP 1120 for any data transmission.

In an example, STA 1112 may receive the beacon frame and may learn of the r-TWT SP 1120 indicated in the beacon frame. Based on receiving the beacon frame, STA 1112 may stop transmitting a data frame with a TID of non-latency sensitive traffic before the start of r-TWT SP 1120. STA 1112 may defer transmission of the data frame until the end of the r-TWT SP 1120.

As such, neither STA 1111 nor STA 1112 uses r-TWT SP 1120 to transmit/receive frames to/from AP 1110 during r-TWT SP 1120. Radio resources of the r-TWT SP 1120 may thus remain unused and are wasted. This results in reduced radio link efficiency.

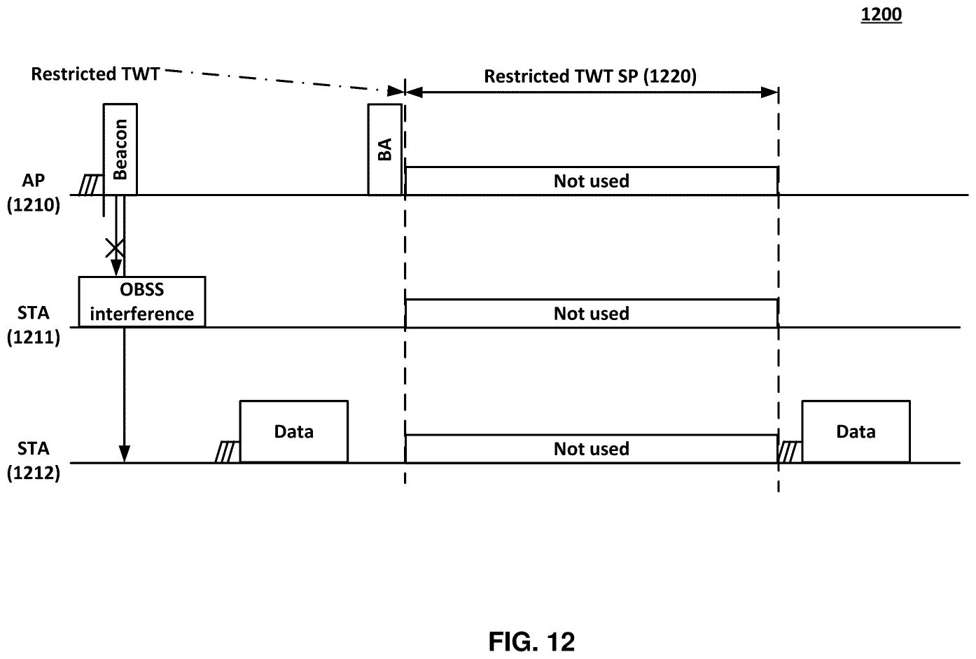

FIG. 12 illustrates an example 1200 of r-TWT operation according to existing technologies. As shown in FIG. 12, example 1200 includes an AP 1210, a first STA 1211, and a second STA 1212.

AP 1210 may transmit a beacon frame including a TWT element for allocating a r-TWT SP 1220 to STA 1211.

In an example, STA 1212 may receive the beacon frame and learn of r-TWT SP 1220 indicated in the beacon frame. STA 1212 may not be a scheduled STA of the r-TWT SP 1220. STA 1212 may stop transmitting a data frame before the start of r-TWT SP 1220. STA 1212 may defer transmission of the data frame until the end of r-TWT SP 1220.

In an example, STA 1211 may be a scheduled STA of r-TWT SP 1220. In an example, STA 1211 may fail to decode the beacon frame that includes the TWT element allocating the r-TWT SP 1220. STA 1211 may thus not learn of r-TWT SP 1220 indicated by the beacon frame and may not transmit or receive any frame to/from AP 1210 during r-TWT SP 1220. As such, radio resources of r-TWT SP 1220 may remain allocated to data frames with TID(s) associated with the r-TWT SP and may be wasted.

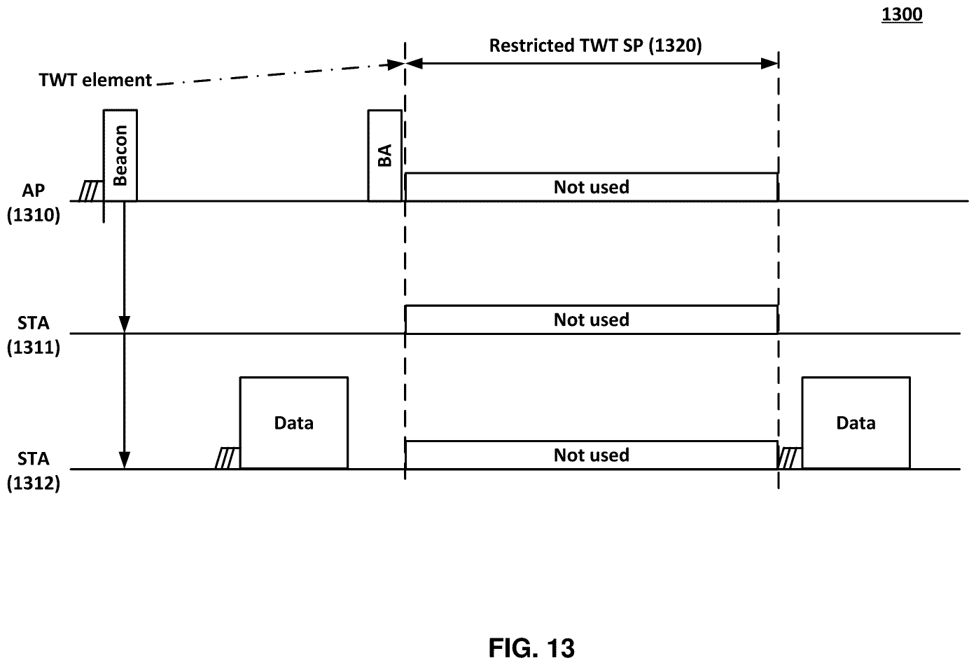

FIG. 13 illustrates an example 1300 of r-TWT operation according to existing technologies. As shown in FIG. 13, example 1300 includes an AP 1310, a first STA 1311, and a second STA 1312.

AP 1310 may transmit a beacon frame including a TWT element for allocating a r-TWT SP 1320 to STA 1311.

In an example, STA 1312 may receive the beacon frame and learn of r-TWT SP 1320. STA 1312 may not be a scheduled STA of r-TWT SP 1320. STA 1312 may stop transmitting a data frame before the start of r-TWT SP 1320. STA 1312 may defer transmission of the data frame until the end of r-TWT SP 1320.

In an example, the STA 1311 may be a scheduled STA of r-TWT SP 1320. STA 1311 may receive the beacon frame and may learn of r-TWT SP 1320. But STA 1311 may not have any buffered frames to transmit during r-TWT SP 1320. As such, radio resources of r-TWT SP 1320 may remain allocated to data frames with TID(s) associated with the r-TWT SP and may be wasted.

As further described below, embodiments provide enhanced TWT/r-TWT operation according to which an AP STA and/or a non-AP STA may terminate a TWT/r-TWT SP based on whether or not the wireless medium is used. Example embodiments thus enhance throughput and efficiency of the wireless medium when TWT/r-TWT is implemented. In one aspect, embodiments enable STA-initiated termination schemes. The STA-initiated terminated schemes allow a STA to terminate a TWT/r-TWT SP under certain conditions, without waiting for explicit termination from the scheduling AP. These schemes may reduce the waste of channel resources when the wireless medium is not being used during the TWT/r-TWT SP and when the AP may be unable to explicitly terminate the TWT/r-TWT SP. In another aspect, embodiments enable AP-initiated TWT/r-TWT SP termination schemes. The termination schemes may include the AP transmitting an explicit indication of termination of a TWT/r-TWT SP. The provided termination schemes address channel access unfairness among STAs that may arise during a TWT/r-TWT SP according to existing technologies.

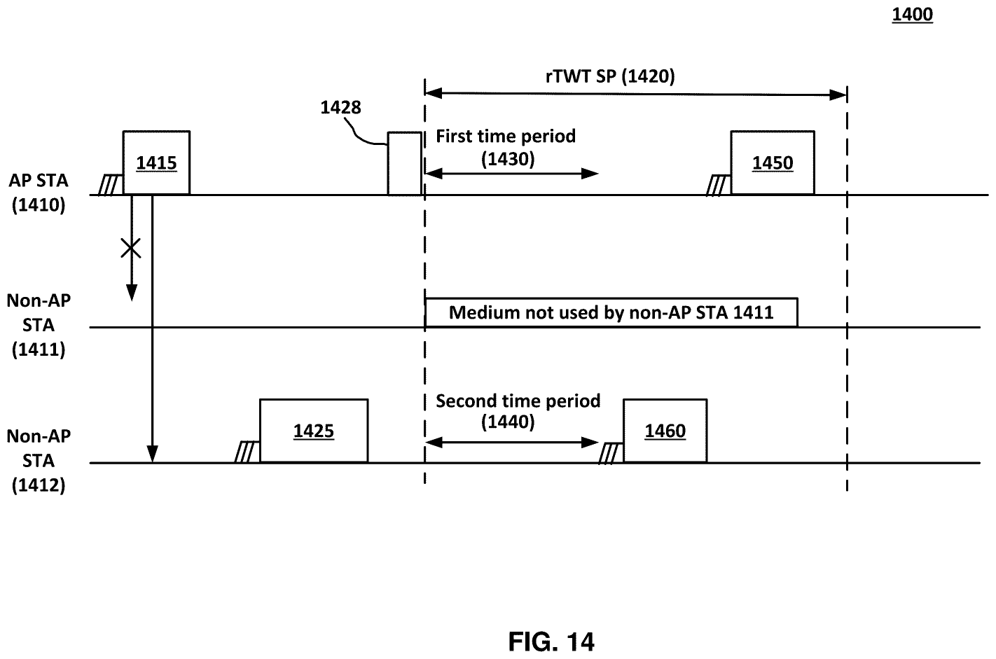

FIG. 14 illustrates an example 1400 of r-TWT SP termination according to an embodiment of the present disclosure. As shown in FIG. 14, example 1400 includes an access point station (AP STA) 1410, a first non-access point station (non-AP STA) 1411, and a second non-AP STA 1412.

In an example, AP STA 1410 may transmit a frame 1415 indicating a r-TWT SP 1420 for one or more non-AP STAs. Frame 1415 may include a TWT element for r-TWT SP 1420. Frame 1415 may further indicate one or more TIDs of MSDUs or A-MSDUs with latency sensitive traffic associated with r-TWT SP 1420. Frame 1415 may be broadcast by AP STA 1410. First frame 1415 may be transmitted periodically. Frame 1415 may comprise an address of AP STA 1410. In an example, frame 1415 may be a beacon frame or a probe response frame.

Before the start of r-TWT SP 1420, traffic with any TID may be transmitted over the wireless medium. For example, AP STA 1410 may receive a data frame 1425 with any TID (e.g., an MSDU or an A-MSDU with a TID that is not necessarily identified in frame 1415 as representing latency sensitive traffic) from non-AP STA 1412. AP STA 1410 may send a Block Ack frame 1428 to non-AP STA 1412 in response to data frame 1425.

Non-AP STA 1411 may be a STA scheduled in r-TWT SP 1420. In an example, however, non-AP STA 1411 may not obtain the information for r-TWT SP 1420, indicated by frame 1415. In an example, non-AP STA 1411 may not use r-TWT SP 1420 for any transmission.

Non-AP STA 1412 may not be scheduled in r-TWT SP 1420. As mentioned above, non-AP STA 1412 may transmit data frame 1425 before the start of r-TWT SP 1420. In an example, upon receiving frame 1415 indicating r-TWT SP 1420, non-AP STA 1412 may stop transmitting data frame 1415 before the start of r-TWT SP 1420. In an example, non-AP STA 1412 may defer enhanced distributed channel access (EDCA) channel access for the transmission of a buffered data frame with any TID until the end of r-TWT SP 1420.

In an embodiment, AP STA 1410 may check whether the wireless medium is used during a first time period 1430 within r-TWT SP 1420. In an example, AP STA 1410 may determine that the wireless medium is not used during first time period 1430. Based on determining that the wireless medium is not used, AP STA 1410 may terminate r-TWT SP 1420. In an embodiment, AP STA 1410 may send a frame 1450 to terminate r-TWT SP 1420. Frame 1450 may be one of a control frame, a management frame, an MSDU with any TID, or an A-MSDU with any TID. Frame 1450 may be transmitted using EDCA channel access.

In an embodiment, non-AP STA 1412 may check whether the wireless medium is used during a second time period 1440 within r-TWT SP 1420. In an example, non-AP STA 1412 may determine that the wireless medium is not used during second time period 1440. Based on determining that the wireless medium is not used, non-AP STA 1412 may terminate r-TWT SP 1420. In an embodiment, non-AP STA 1412 may send a frame 1460 to terminate r-TWT SP 1420. Frame 1460 may be one of a control frame, a management frame, an MSDU with any TID, or an A-MSDU with any TID. Frame 1460 may be transmitted using EDCA channel access.

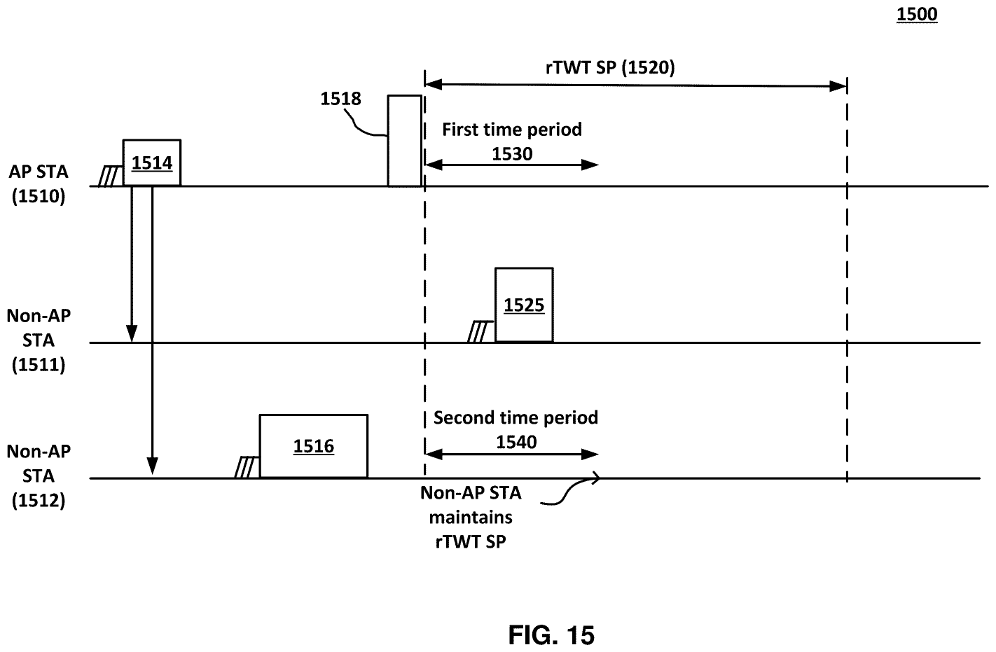

FIG. 15 illustrates an example 1500 of r-TWT operation according to an embodiment. As shown in FIG. 15, example 1500 includes an AP STA 1510, a first non-AP STA 1511, and a second non-AP STA 1512.

In an example, AP STA 1510 may transmit a frame 1514 indicating a r-TWT SP 1520 for one or more non-AP STAs. Frame 1514 may include a TINT element for r-TWT SP 1520. Frame 1514 may further indicate one or more TIDs of MSDUs or A-MSDUs with latency sensitive traffic associated with r-TWT SP 1520. Frame 1514 may be transmitted periodically. Frame 1514 may comprise an address of AP STA 1510. In an example, frame 1514 may be a beacon frame or a probe response frame.

Before the start of r-TWT SP 1520, traffic with any TID may be transmitted over the wireless medium. For example, AP STA 1510 may receive a data frame 1516 with any TID (e.g., an MSDU or an A-MSDU with a TID that is not necessarily identified in frame 1415 as representing latency sensitive traffic) from non-AP STA 1512. AP STA 1510 may send a Block Ack frame 1518 to non-AP STA 1512 in response to data frame 1516.

Non-AP STA 1511 may be a STA scheduled in r-TWT SP 1520. In an example, non-AP STA 1511 receives frame 1514 and obtains the information for r-TWT SP 1520 indicated by frame 1514. As such, non-AP STA 1511 may send a frame 1525 during r-TWT SP 1520 to AP STA 1510. Frame 1525 may be an MSDU or an A-MSDU with a TID identified in frame 1514 as representing latency sensitive traffic.

Non-AP STA 1512 may not be scheduled in r-TWT SP 1520. As mentioned above, non-AP STA 1512 may transmit data frame 1516 before the start of r-TWT SP 1520. In an example, upon receiving frame 1514 indicating r-TWT SP 1520, non-AP STA 1512 may stop transmitting data frame 1516 before the start of r-TWT SP 1520. In an example, non-AP STA 1512 may defer EDCA channel access for transmission of a buffered data frame with any TID until the end of the r-TWT SP 1520.

In an embodiment, AP STA 1510 may check whether the wireless medium is used during a first time period 1530 within r-TWT SP 1520. In an example, based on frame 1525 transmitted by non-AP STA 1511, AP STA 1510 may determine that the wireless medium is used during first time period 1530. Based on determining that the wireless medium is used during first time period 1530, AP STA 1510 may decide to maintain (i.e., not prematurely terminate) r-TWT SP 1520.

In an embodiment, non-AP STA 1512 may check whether the wireless medium is used during a second time period 1540 within r-TWT SP 1520. In an example, based on frame 1525 transmitted by non-AP STA 1511, non-AP STA 1512 may determine that the wireless medium is used during second time period 1540. Based on determining that the wireless medium is used during second time period 1540, non-AP STA 1512 may decide to maintain (i.e., not prematurely terminate) r-TWT SP 1520. For example, non-AP STA 1512 may defer EDCA channel access for transmission of a buffered data frame with any TID until the end of r-TWT SP 1520.

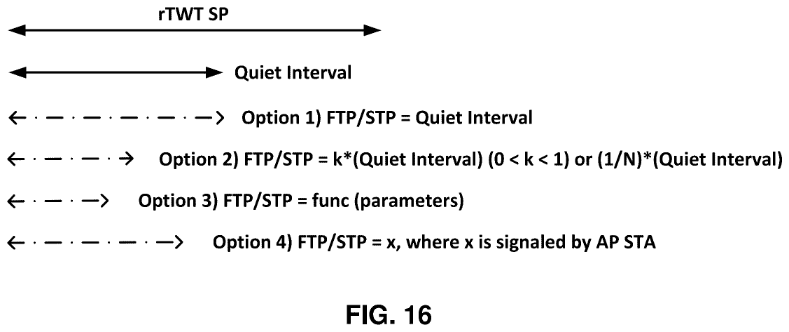

FIG. 16 illustrates example of methods for setting or determining the value of the first time period (FTP) and/or the second time period (STP) discussed above. These example methods are provided for the purpose of illustration only and are not limiting of embodiments of the present disclosure.

As shown in FIG. 16, in a first example option (Option 1), the FTP and/or the STP may be set based on a quiet interval which may overlap with (or be within) the r-TWT SP. For example, the FTP and/or the STP may be set to the same value as the quiet interval. For example, the FTP and/or the STP may be set to 1 TU (e.g., 1024 us) (e.g. in IEEE 802.11be) plus a value n (e.g. n=0, 10 us). As mentioned above, the quiet interval may be a period during which certain non-AP STAs may transmit no messages or signals associated with IEEE 802.11 standard technologies in one or more frequency bands.

In a second example option (Option 2), as shown in FIG. 16, the FTP and/or the STP may be set to a value lower than a quiet interval. In an embodiment, the FTP and/or STP may be set to k*(Quiet Interval), where 0<k<1. For example, if the quiet interval is 1 TU, the FTP and/or STP may be set to k TU+n, where 0<k<1 and, e.g., n=0 us, 10 us, etc. Alternatively, the FTP and/or the STP may be set to 1/N times of the quiet interval, where N is a constant positive integer. The value of N and/or k may be indicated or signaled by an element in a frame transmitted by the AP STA. Alternatively or additionally, the value of N and/or k may be a fixed value (e.g., 2 or 4). The value of N and/or k for the FTP may be equal or different than the respective value (N and/or k) for the STP.

In a third example option (Option 3), as shown in FIG. 16, the FTP and/or the STP may be set based on a function of one or more radio link parameters, e.g. r-TWT EDCA, AIFS, SIFS, CWmin, RTS TX time, CTS TX time, etc. In an example, the FTP and/or the STP may be set to the value of a r-TWT EDCA time. The r-TWT EDCA time may be based on at least one of: AIFS [AC], CWmin[AC], and/or RTS TX time. The AC may be an access category for a TID identified in a TWT element for the r-TWT SP. For example, r-TWT EDCA time may be equal to AIFS [AC]+CWmin[AC]+RTS TX. In another example, r-TWT EDCA time may be equal to AIFS [AC]+CWmin[AC]+RTS TX+n (e.g. n=0, 10 us). In an embodiment, if more than one value is derived for the FTP value, the largest value may be applied. In an example, the STP may be set to the value of r-TWT EDCA time, wherein the r-TWT EDCA is equal to AIFS [AC]+CWmin[AC]+RTS TX time+SIFS+CTS TX time, where the AC is an access category for a TID identified in a TWT element for the r-TWT SP. In an embodiment, if more than one value is derived for the STP value, the largest value may be applied. In an example, the FTP may be equal to the STP. In an example, the STP may be different from the FTP by a pre-defined time value. For example, STP may be equal to the FTP plus a predetermined value. In an example implementation, the function for determining the FTP increases wireless medium channel efficiency. The FTP may be set to be a short time duration to leave enough time for transmission of frames while simultaneously allowing a correct determination (e.g., by an AP STA) that the wireless medium is not going to be used.

In a fourth example option (Option 4), as shown in FIG. 16, the FTP and/or the STP may be indicated by one element in a frame transmitted by the AP STA. The STA may determine the FTP and/or the STP based on the element. The frame may be one of the following: a beacon frame, a probe response frame, an association response frame and/or an action frame, wherein the at least one element is a TINT element. The AP STA may further determine the FTP and/or the STP based on an access category of at least one TID of the one or more TIDs. In an example, a value of the FTP may be different from a value of the STP.

In an example, the FTP and/or the STP may be based on an r-TWT carrier sense duration (CSD). For example, the FTP and/or the STP may be set to r-TWT CSD+n (e.g. n=0 us, 10 us, etc.).

In an example, the FTP and/or the STP any be any duration within the r-TWT SP. For example, the FTP and/or the STP may be a period of inactivity after a first frame transmission during the r-TWT SP. In an example, the FTP and/or the STP may start at a predetermined time n (e.g. n=0 us, 10 us, etc.) after the beginning of the TINT SP.

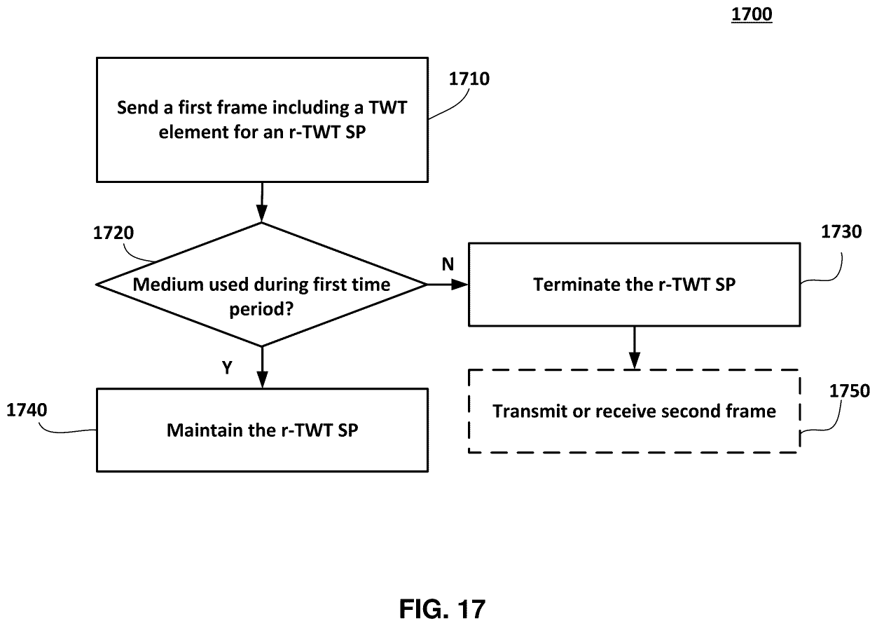

FIG. 17 illustrates an example process 1700 for r-TWT operation according to an embodiment. Example process 1700 is provided for the purpose of illustration only and is not limiting of embodiments. Example process 1700 may be performed by an AP STA.

As shown in FIG. 17, example process 1700 begins in step 1710, which includes sending a first frame including a TINT element for an r-TWT SP. The first frame may be a beacon frame or a probe response frame.

Subsequently, in step 1720, process 1700 may include determining whether a wireless medium is used during a first time period within the r-TWT SP.

If, in step 1720, the wireless medium is determined not to be used, process 1700 transitions to step 1730, which includes terminating the r-TWT SP. Subsequently, process 1700 may proceed to step 1750, which may include transmitting or receiving a second frame after the r-TWT SP termination. The second frame may be one of a control frame, a management frame, an MSDU with any TID, or an A-MSDU with any TID.

Otherwise, if, in step 1720, the wireless medium is determined to be used during the first time period, process 1700 may transition to step 1740, which includes maintaining the r-TWT SP.

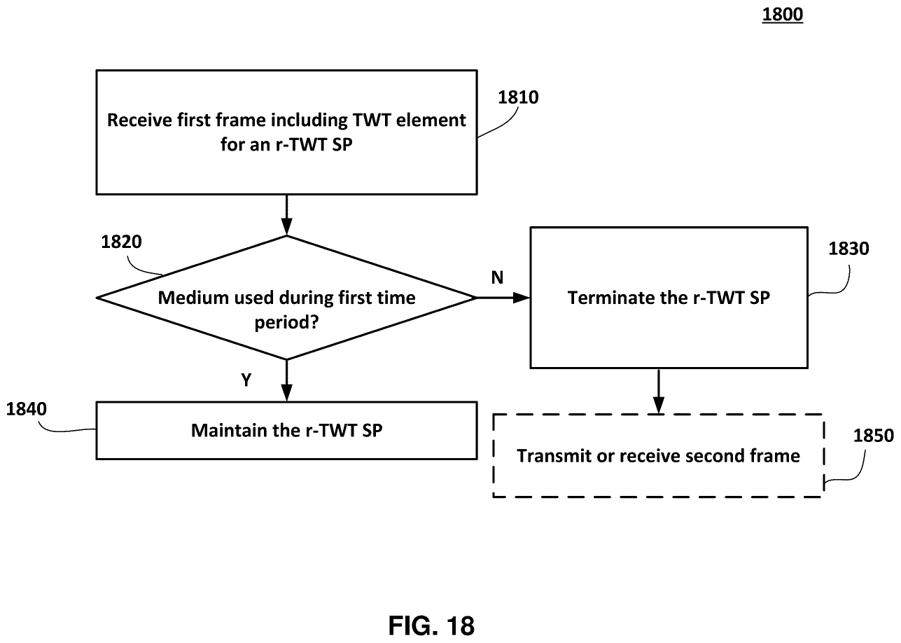

FIG. 18 illustrates an example process 1800 for r-TWT operation according to an embodiment. Example process 1800 is provided for the purpose of illustration only and is not limiting of embodiments. Example process 1800 may be performed by an non-AP.

As shown in FIG. 18, process 1800 begins in step 1810, which includes receives a first frame including a TINT element for an r-TWT SP. The first frame may be a beacon frame or a probe response frame.

Subsequently, in step 1820, process 1800 may include determining whether a wireless medium is used during a second time period within the r-TWT SP.

If, in step 1820, the wireless medium is determined not to be used during the second time period, process 1800 transitions to step 1830, which includes terminating the r-TWT SP. Subsequently, process 1800 may proceed to step 1850, which may include transmitting or receiving a second frame after the r-TWT SP termination. The second frame may be one of a control frame, a management frame, an MSDU with any TID, or an A-MSDU with any TID. In an embodiment, the second frame may be transmitted using EDCA channel access.

Otherwise, if, in step 1820, the wireless medium is determined to be used during the second time period, process 1800 may transition to step 1840, which includes maintaining the r-TWT SP.

In existing WLAN systems, an AP may allocate a trigger-enabled TWT SP to a STA that supports TWT operation. The allocated STA may be allowed to transmit a frame during the trigger-enabled TWT SP after receiving a trigger frame from the AP. That is, the STA may not transmit a frame by using EDCA operation during the trigger-enabled TWT SP.

In an example, an AP may allocate a trigger-enabled r-TWT SP to a STA that supports r-TWT operation. In a trigger-enabled r-TWT SP, the r-TWT scheduling AP may first trigger member r-TWT scheduled STAs to allow them to first deliver their QoS data frames. In a triggered-enabled r-TWT SP, a member r-TWT scheduled STA may transmit an UL frame to a r-TWT scheduled AP in response to a trigger frame received from the AP. In a triggered-enabled r-TWT SP, a transmission of the member r-TWT scheduled STA may not be allowed by using EDCA.

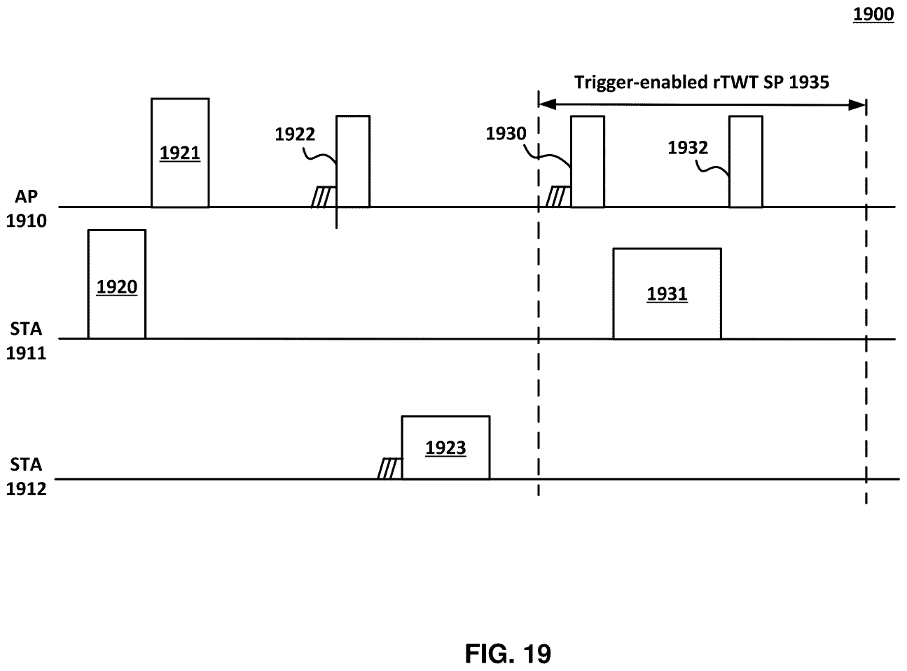

FIG. 19 illustrates an example 1900 of trigger-enabled r-TWT SP operation. As shown in FIG. 19, example 1900 includes an AP 1910, a STA 1911, and a STA 1912.

In an example, STA 1911 may transmit a TWT setup request frame 1920 to AP 1910. TWT setup request frame 1920 may include first parameters for a trigger-enabled r-TWT SP 1935. In response to frame 1920, AP 1910 may transmit a TWT setup response frame 1921 to STA 1911. TWT setup response frame 1921 may include second parameters for the trigger-enabled r-TWT SP 1935. The second parameters may or may not be the same as the first parameters.

In an example, TWT setup request frame 1920 and/or TWT setup response frame 1921 may comprise TID bitmaps indicating TIDs corresponding to DL or UL traffic. The DL/UL traffic indicated in the TID bitmaps may represent DL/UL traffic that may be transmitted during the trigger-enabled r-TWT SP 1935.

Upon successful TWT setup by exchanging TWT setup request frame 1920 and TWT setup response frame 1921, STA 1911 may be a member r-TWT scheduled STA of the trigger-enabled r-TWT SP 1935. In other words, STA 1911 may be allowed to transmit in response to a received trigger frame during the triggered-enabled r-TWT SP 1935.

Subsequently, A P 1910 may transmit a beacon frame 1922 comprising a TWT element indicating scheduling information of the trigger-enabled r-TWT SP 1935. The scheduling information may indicate a start time and an end time of the trigger-enabled r-TWT SP 1935. In an example, frame 1922 may other than a beacon frame. For example, frame 1922 may be a broadcast probe response frame, a fast initial link setup (FILS) discovery frame, or a traffic indication map (TIM) broadcast frame.

In an example, STA 1912 may not be a member r-TWT scheduled STA of the trigger-enabled r-TWT SP 1935. As shown in FIG. 19, STA 1912 may transmit a data frame 1923 by using EDCA before the start of the trigger-enabled r-TWT SP 1935. However, S T A 1912 stops transmitting data frame 1923 before the start of the trigger-enabled r-TWT SP 1935.

At the start of the trigger-enabled r-TWT SP 1935, AP 1910 may transmit a trigger frame 1930 to STA 1911. In response to trigger frame 1930, STA 1911 may transmit a TB PPDU 1931 to AP 1910. TB PPDU 1931 may include UL traffic that is permitted to be transmitted during the trigger-enabled r-TWT SP 1935, i.e., having a TID that belongs to the TIDs indicated in the TID bitmaps exchanged by frames 1920 and 1921. AP 1910 may transmit a Block Ack (BA) frame 1932 in response to TB PPDU 1931. BA frame 1932 may be a multi-STA BA frame.

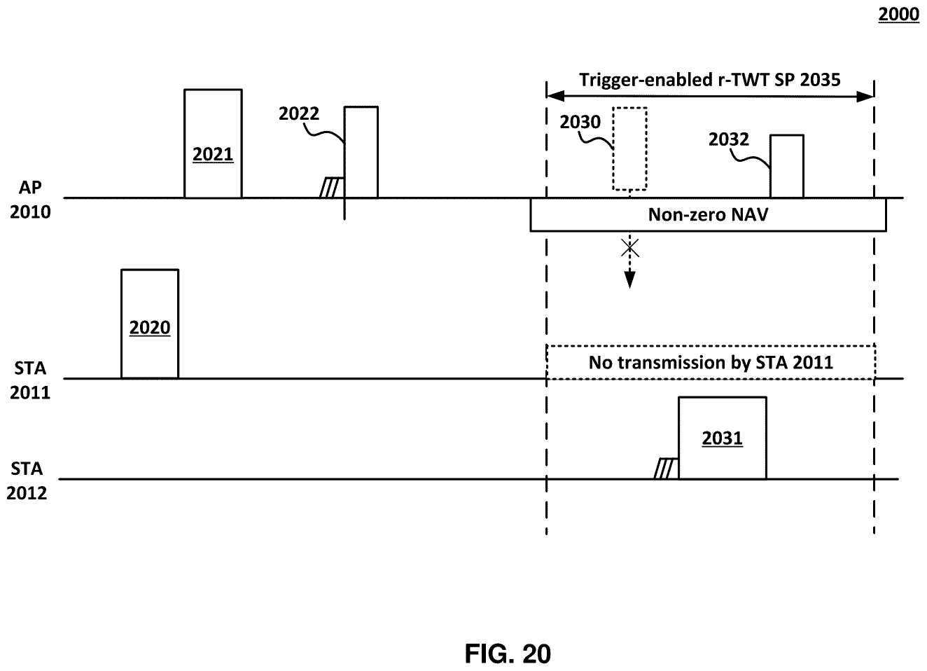

FIG. 20 illustrates another example 2000 of trigger-enabled r-TWT SP operation. As shown in FIG. 20, example 2000 includes an AP 2010, a STA 2011, and a STA 2012.

In an example, STA 2011 may transmit a TWT setup request frame 2020 to AP 2010. TWT setup request frame 2020 may include first parameters for a trigger-enabled r-TWT SP 2035. In response to TWT setup request frame 2020, AP 2010 may transmit a TWT setup response frame 2021 to STA 2011. TWT setup response frame 2021 may include second parameters for the trigger-enabled r-TWT SP 2035. The second parameters may or may not be the same as the first parameters.

In an example, TWT setup request frame 2020 and/or TWT setup response frame 2021 may comprise TID bitmaps indicating TIDs corresponding to DL or UL traffic. The DL/UL traffic indicated in the TID bitmaps may represent DL/UL traffic that may be transmitted during the trigger-enabled r-TWT SP 2035.

Upon successful TWT setup by exchanging TWT setup request frame 2020 and TWT setup response frame 2021, STA 2011 may be a member r-TWT scheduled STA of the trigger-enabled r-TWT SP 2035. In other words, STA 2011 may be allowed to transmit in response to a received trigger frame during the triggered-enabled r-TWT SP 2035.

Subsequently, A P 2010 may transmit a beacon frame 2022 comprising a TWT element indicating scheduling information of the trigger-enabled r-TWT SP 2035. The scheduling information may indicate a start time and an end time of the trigger-enabled r-TWT SP 2035.

As described above with reference to FIG. 19, in trigger-enabled r-TWT, AP 2010 may be expected to transmit a trigger frame to STA 2011 at the start of the trigger-enabled r-TWT SP. The trigger frame triggers member r-TWT scheduled STA 2011 to transmit its latency sensitive traffic during the trigger-enabled r-TWT SP. In an example, as shown in FIG. 20, AP 2010 may not be able to transmit a trigger frame 2030 during the trigger-enabled r-TWT SP 2035. For example, AP 2010 may not be able to transmit trigger frame 2030 based on a carrier sensing indicating a busy medium. For example, a NAV value of AP 2010 may be a non-zero value during the trigger-enabled r-TWT SP 2035.

As a result of AP 2010 not transmitting trigger frame 2030, STA 2011 may not receive a trigger frame 2030 from AP 2010 during the trigger-enabled r-TWT SP 2035. STA 2011 may thus not transmit any frame during the trigger-enabled r-TWT SP 2035. In particular, STA 2011 may not transmit during the trigger-enabled r-TWT SP 2035 despite having buffered latency sensitive traffic ready for transmission and/or the carrier sensing result indicating idle medium.

In an example, STA 2012 may not be a member r-TWT scheduled STA of the trigger-enabled r-TWT SP 2035. However, in an example, STA 2012 may still transmit a data frame 2031 to AP 2010 by using EDCA during the trigger-enabled r-TWT SP 2035. For example, STA 2012 may transmit a frame 2031 after a quiet interval has elapsed from the start of the trigger-enabled rTWP SP 2035. Alternatively, S T A 2012 may be an EHT STA that does not support r-TWT or a legacy non-EHT STA and may thus not follow r-TWT procedure (if STA 2012 followed r-TWT procedure STA 2012 would remain silent during the r-TWT SP). Frame 2031 may include non-latency sensitive traffic. AP 2010 may transmit a BA frame 2032 in response to the frame 2031 to STA 2012.

Thus, according to example 2000, latency sensitive traffic of STA 2011 may be delayed or discarded despite STA 2011 being a member r-TWT scheduled STA of the trigger-enabled r-TWT SP 2035. In contrast, non-latency sensitive traffic of STA 2012 may be transmitted during the trigger-enabled r-TWT SP 2035.

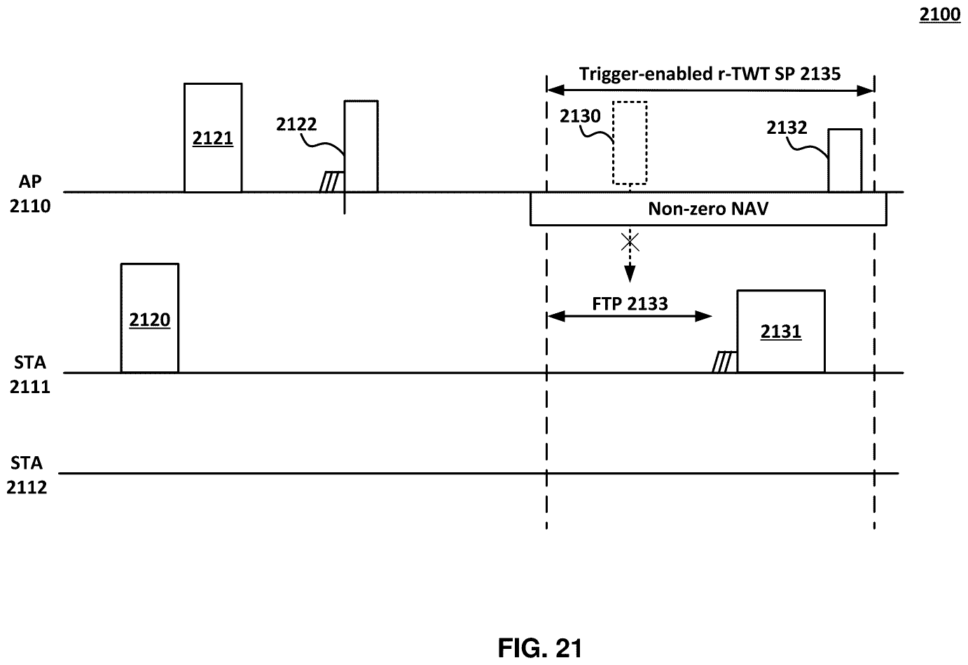

FIG. 21 illustrates an example 2100 of trigger-enabled r-TWT SP operation according to an embodiment. As shown in FIG. 21, example 2100 includes an AP 2110, a STA 2111, and a STA 2112.

In an example, STA 2111 may transmit a TWT setup request frame 2120 to AP 2110. TWT setup request frame 2120 may include first parameters for a trigger-enabled r-TWT SP 2135. In response to TWT setup request frame 2120, AP 2110 may transmit a TWT setup response frame 2121 to STA 2111. TWT setup response frame 2121 may include second parameters for the trigger-enabled r-TWT SP 2135. The second parameters may or may not be the same as the first parameters.

In an example, TWT setup request frame 2120 and/or TWT setup response frame 2121 may comprise TID bitmaps indicating TIDs corresponding to DL or UL traffic. The DL/UL traffic indicated in the TID bitmaps may represent DL/UL traffic that may be transmitted during the trigger-enabled r-TWT SP 2135.

Upon successful TWT setup by exchanging TWT setup request frame 2120 and TWT setup response frame 2121, STA 2111 may be a member r-TWT scheduled STA of the trigger-enabled r-TWT SP 2135. In other words, STA 2111 may be allowed to transmit during the triggered-enabled r-TWT SP 2135.

Subsequently, AP 2110 may transmit a beacon frame 2122 comprising a TWT element indicating scheduling information of the trigger-enabled r-TWT SP 2135. The scheduling information may indicate a start time and an end time of the trigger-enabled r-TWT SP 2135.

As described above with reference to FIG. 19, in trigger-enabled r-TWT SP 2135, AP 2110 may be expected to transmit a trigger frame to STA 2111 at the start of the trigger-enabled r-TWT SP 2135. The trigger frame triggers member r-TWT scheduled STA 2111 to transmit its latency sensitive traffic during the trigger-enabled r-TWT SP 2135. In an example, as shown in FIG. 21, AP 2110 may not be able to transmit a trigger frame 2130 during the trigger-enabled r-TWT SP 2135. For example, AP 2110 may not be able to transmit trigger frame 2130 based on a carrier sensing indicating a busy medium. For example, a NAV value of AP 2110 may be a non-zero value during the trigger-enabled r-TWT SP 2135.

In an embodiment, STA 2111 may be configured not to transmit on the wireless medium without receiving a trigger frame from AP 2110 during the trigger-enabled r-TWT SP 2135.

In another embodiment, STA 2111 may be configured to determine that the wireless medium is not used based on not receiving a frame from AP 2110 during a first time period (FTP) 2133 of the trigger-enabled r-TWT SP. A value of FTP 2133 may be signaled by a frame (e.g., frame 2121 or frame 2122) sent by AP 2110. The frame may be a data frame, a control frame, a management frame (e.g., a TWT setup (response) frame, a beacon frame, a probe response frame, an association response frame, FILS discovery frame, or a TIM broadcast frame), QoS data/null frame, or an action (response) frame. The QoS data/null frame may comprise A-control field including a value of FTP 2133.

In another embodiment, a value of FTP 2133 may be signaled by a frame (e.g., frame 2120) sent by STA 2111. The frame may be a data frame, a control frame, a management frame (e.g., a TWT setup (request) frame, a probe request frame, an association request frame), QoS data/null frame, or an action (request) frame. The QoS data/null frame may comprise A-control field including a value of FTP 2133.

The FTP 2133 may start at the beginning of the trigger-enabled r-TWT SP. In an example, STA 2111 may determine that the wireless medium is not used based on not receiving a second frame from AP 2110 during FTP 2132. In an example, the second frame may be any frame in accordance with the IEEE 802.11 standard. In an example, the second frame may be a trigger frame. In an example, the second frame may be a data frame, a control frame, a management frame, or an action frame.

Based on determining that the wireless medium is not used (i.e., not receiving a frame from AP 2110 during FTP 2132), STA 2111 may be able to transmit a non-trigger based frame on the wireless medium following FTP 2132 of the trigger-enabled r-TWT SP 2135. The non-trigger based frame may be a frame that is transmitted using a contention based channel access scheme. The contention based channel access scheme may be a distributed coordination function (DCF) scheme, an enhanced distributed channel access (EDCA) scheme, or a listen before talk (LBT) scheme. Additionally or alternatively, STA 2111 may be configured to receive a trigger frame from AP 2110 before transmitting during the trigger-enabled r-TWT SP 2135.

Returning to example 2100, STA 2111 may determine that the wireless medium is not used based on not receiving trigger frame 2130 from AP 2110 during FTP 2133. Based on this determination, STA 2111 may transmit a frame 2131 on the wireless medium following FTP 2133 of the trigger-enabled r-TWT SP 2135. Additionally, STA 2111 may terminate the trigger-enabled r-TWT SP 2135. The terminating of the r-TWT SP 2135 may include terminating (i.e., no longer following) a configuration at STA 2111 according to which STA 2111 should wait to receive a trigger frame from AP 2110 before transmitting during the trigger-enabled r-TWT SP 2135. Frame 2131 may be a non-trigger based frame. The non-trigger based frame may be a frame that is transmitted using a contention based channel access scheme. The contention based channel access scheme may be a distributed coordination function (DCF) scheme, an enhanced distributed channel access (EDCA) scheme, or a listen before talk (LBT) scheme. Frame 2131 may include latency sensitive traffic or non-latency sensitive traffic. AP 2110 may transmit a BA frame 2132 in response to frame 2131.

In another aspect, embodiments, as further described below, provide AP-initiated TWT termination schemes. The termination schemes may include the AP transmitting an explicit indication of termination of a TWT SP. The provided termination schemes address channel access unfairness among STAs that may arise during a TWT SP according to existing technologies. Additionally, the provided termination schemes may reduce the waste of channel resources due to a TWT SP being unused by member TWT scheduled STAs.

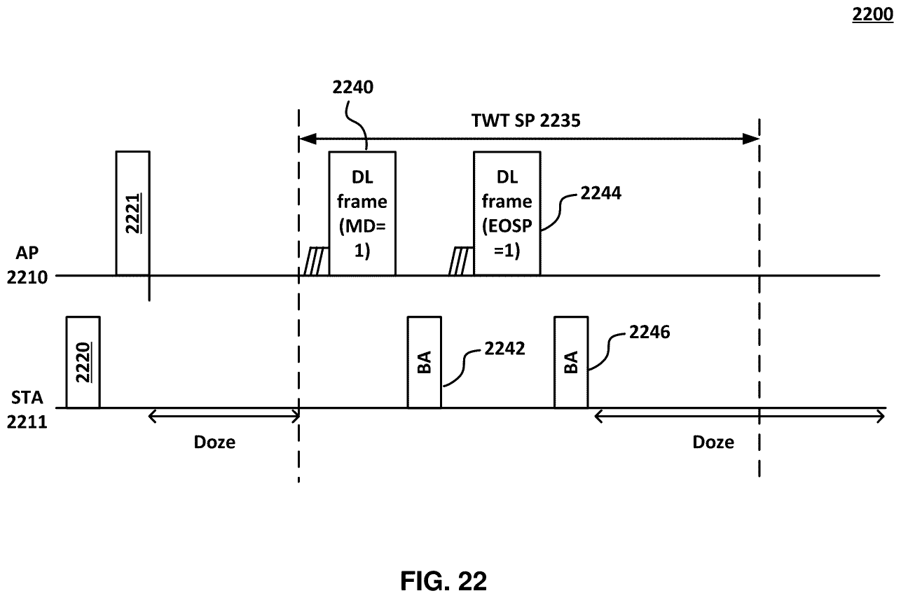

FIG. 22 illustrates an example 2200 of TWT operation. As shown in FIG. 22, example 2200 includes an AP 2210 and a STA 2211. In an example, STA 2211 may transmit a TWT setup request frame 2220 to AP 2210. TWT setup request frame 2220 may request the setup of an individual TWT agreement. TWT setup request frame 2220 may include first parameters for a TWT SP 2235. In response to TWT setup request frame 2220, AP 2210 may transmit a TWT setup response frame 2221 to STA 2211. TWT setup response frame 2221 may indicate acceptance of the requested TWT agreement. The TWT agreement may be set up as an unannounced TWT. TWT setup response frame 2121 may include second parameters for the trigger-enabled r-TWT SP 2235. The second parameters may or may not be the same as the first parameters. After the TWT agreement setup, STA 2211 may enter a doze state until the start of TWT SP 2235.

During TWT SP 2235, AP 2210 may transmit a downlink frame 2240. In an example, frame 2240 may include a more data (MD) field of the MAC header set to 1 when AP 2210 has more data frames to send to STA 2211. STA 2211 may transmit a BA frame 2242 to AP 2210 in response to frame 2240. Subsequently, AP 2210 may transmit to STA 2211 a downlink frame 2244. In an example, downlink frame 2244 may be the last frame in a buffer at AP 2210 containing frames for transmission to STA 2211. As such, AP 2210 may set an end of service period (EOSP) field (of a QoS control field) of frame 2244 to 1. Upon receiving frame 2244 with the EOSP field set to 1, STA 2211 may transmit a BA frame 2246 to AP 2210. Subsequently, STA 2211 may return to the doze state. STA 2211 may remain in the doze state until a next scheduled TWT SP of the setup TWT agreement. Thus, according to this example operation, an EOSP field set to 1 in an individually addressed frame may indicate the end/termination of a TWT SP to a TWT STA. The TWT STA may enter a doze state after receiving the frame to reduce power consumption.

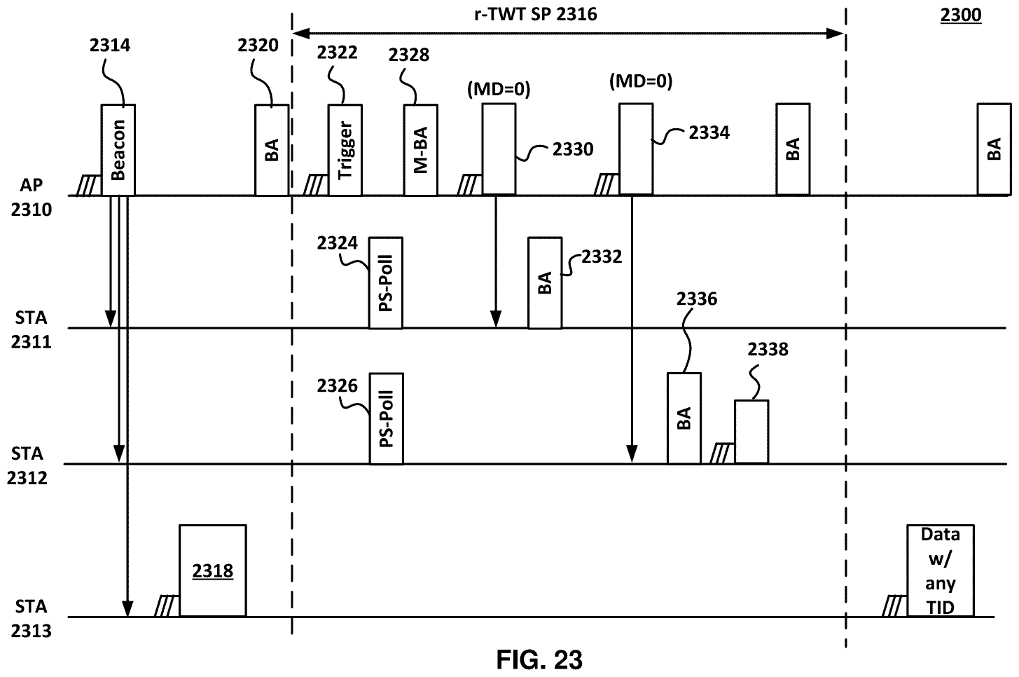

FIG. 23 illustrates an example 2300 of r-TWT operation. As shown in FIG. 23, example 2300 includes an AP 2310 and STAs 2311, 2312, and 2313. In an example, AP 2310 may be a TWT scheduling AP. AP 2310 may transmit a beacon frame 2314 including a TWT element. The TWT element may indicate a r-TWT SP 2316 of a setup r-TWT. The TWT element may indicate one or more TIDs of latency sensitive traffic associated with the r-TWT. In an example, STAs 2311 and 2312 may be member TWT scheduled STAs of the r-TWT. STA 2313 may be a non-member of the r-TWT.

In an example, based on receiving beacon frame 2314, STA 2313 may end a transmission of a frame 2318 (which may include data with any TID) before the start of r-TWT SP 2316. AP 2310 may acknowledge frame 2318 by transmitting a BA frame 2320 to STA 2313. STAs 2311 and 2312 may enter a doze state upon receiving beacon frame 2314 and may remain in the doze state until the start of r-TWT SP 2316.

In an example, AP 2310 may transmit a trigger frame 2322 at the start of r-TWT SP 2316. Trigger frame 2322 may trigger uplink transmissions from member STAs 2311 and 2312. For example, STAs 2311 and 2312 may respond to trigger frame 2322 by transmitting PS-Poll frames 2324 and 2326, respectively. PS-Poll frames 2324 and 2326 indicate to AP 2310 that STAs 2311 and 2312 are awake. AP 2310 may an acknowledgment frame 2328 (e.g., a multi-STA BA frame) in response to PS-Poll frames 2324 and 2326.

Subsequently, AP 2310 may transmit one or more frames containing latency sensitive traffic associated with the r-TWT to STAs 2311 and 2312 during r-TWT SP 2316.

In existing technologies, when AP 2310 has no more DL BUs for STA 2311 or 2312, AP 2310 may set to 0 a more data (MD) field of the last transmitted frame (with latency sensitive traffic) to STA 2311 or 2312. For example, as shown in FIG. 23, when AP 2310 has no more DL BUs for STA 2311, AP 2310 may transmit to STA 2311 a frame 2330 including latency sensitive traffic and having an MD field set to 0. Similarly, when AP 2310 has no more DL BUs for STA 2312, AP 2310 may transmit to STA 2312 a frame 2334 including latency sensitive traffic and having an MD field set to 0. STAs 2311 and 2312 may acknowledge frames 2330 and 2334 by transmitting respectively BA frames 2332 and 2336 to AP 2310. Subsequently, STAs 2311 and 2312 may consider r-TWT SP 2316 terminated. For the remainder of r-TWT SP 2316, STAs 2311 and 2312 may operate outside of r-TWT operation rules. For example, if STA 2311 has no traffic to transmit, STA 2311 may return to the doze state. For example, if STA 2312 has uplink traffic to transmit, STA 2312 may proceed to transmit a data frame 2338 regardless of the TID associated with the traffic. In other words, STA 2312 may transmit during the remainder of r-TWT SP 2316 traffic not associated with the setup r-TWT (e.g., non-latency sensitive).

Being a non-member of the r-TWT, STA 2313 may not access the channel during r-TWT SP 2316 or during at least a quiet interval within r-TWT SP 2316. In contrast, as described above, member STAs that terminate r-TWT SP 2316 may transmit frames with any TID during the remainder of r-TWT SP 2316. This may result in an unfair situation in which STA 2313 may have to defer channel access till the end of r-TWT SP 2316, while STAs 2311 and 2312 may access the channel freely due to early r-TWT SP termination.

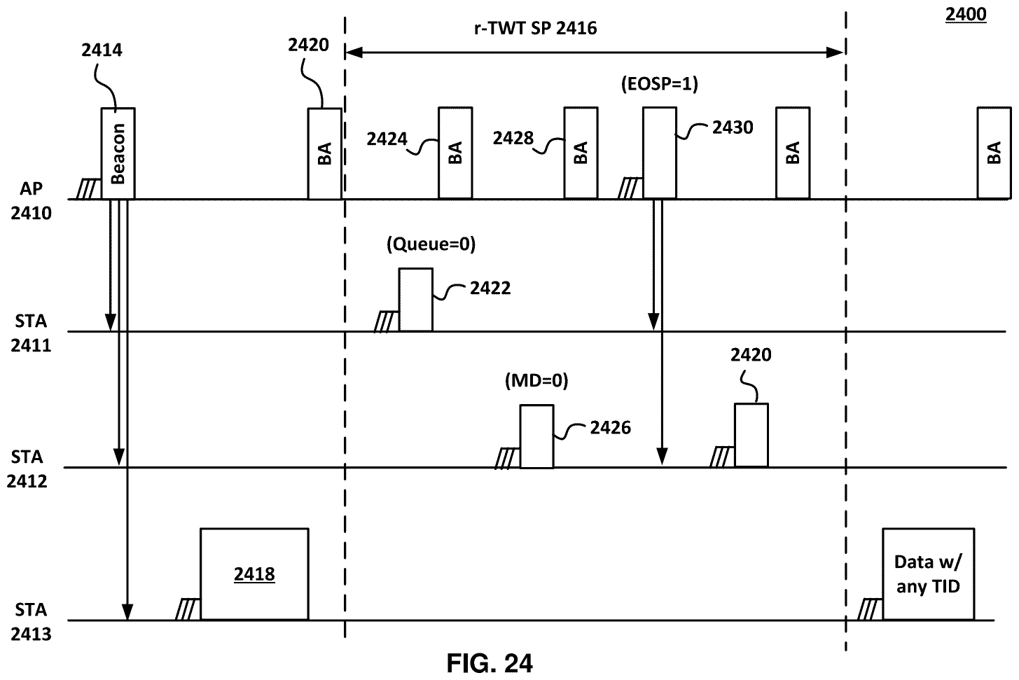

FIG. 24 illustrates an example 2400 of r-TWT operation. As shown in FIG. 24, example 2400 includes an AP 2410 and STAs 2411, 2412, and 2413. In an example, AP 2410 may be a TWT scheduling AP. AP 2410 may transmit a beacon frame 2414 including a TWT element. The TWT element may indicate a r-TWT SP 2416 of a setup r-TWT. The TWT element may indicate one or more TIDs of latency sensitive traffic associated with the r-TWT. In an example, STAs 2411 and 2412 may be member TWT scheduled STAs of the r-TWT. STA 2413 may be a non-member of the r-TWT.

In an example, based on receiving beacon frame 2414, STA 2413 may end a transmission of a frame 2418 (which may include data with any TID) before the start of r-TWT SP 2416. AP 2410 may acknowledge frame 2418 by transmitting a BA frame 2420 to STA 2413. STAs 2411 and 2412 may enter a doze state upon receiving beacon frame 2414 and may remain in the doze state until the start of r-TWT SP 2416.

In an example, after the start of r-TWT SP 2416, STA 2411 and/or STA 2412 may transmit one or more frames containing latency sensitive traffic associated with the r-TWT to AP 2410. When STA 2411 and/or STA 2412 have no more buffered latency sensitive traffic associated with the r-TWT, STA 2411 and/or STA 2412 may transmit a data frame comprising a TID associated with the r-TWT and having a queue size field (of a QoS control field) set to 0 and/or a more data (MD) field set to 0. For example, as shown in FIG. 24, STA 2411 may transmit a frame 2422 comprising a TID associated with the r-TWT and having a queue size field set to 0 to indicate no more buffered latency sensitive traffic at STA 2411. STA 2412 may transmit a frame 2426 comprising a TID associated with the r-TWT and having an MD field set to 0 to indicate no more buffered latency sensitive traffic at STA 2412. AP 2410 may acknowledge frames 2422 and 2426 by transmitting BA frames 2424 and 2428 to STAs 2411 and 2412 respectively.

In existing technologies, upon reception of frame 2422 with the queue size field set to 0 and/or frame 2426 with the MD field set to 0, AP 2410 may transmit a QoS null frame 2430 with an EOSP field (of a QoS Control field) set to 1 to STA 2411 and/or STA 2412. QoS null frame 2430 indicates the end of r-TWT SP 2416. Subsequently, STAs 2411 and 2412 may consider r-TWT SP 2416 terminated. For the remainder of r-TWT SP 2416, STAs 2411 and 2412 may operate outside of r-TWT operation rules. For example, if STA 2411 has no traffic to transmit, STA 2411 may return to the doze state. For example, if STA 2412 has uplink traffic to transmit, STA 2412 may proceed to transmit a data frame 2420 regardless of the TID associated with the traffic. In other words, STA 2412 may transmit during the remainder of r-TWT SP 2416 traffic not associated with the setup r-TWT (e.g., non-latency sensitive).

Being a non-member of the r-TWT, STA 2413 may not access the channel during r-TWT SP 2416 or during at least a quiet interval within r-TWT SP 2416. In contrast, as described above, member STAs that terminate r-TWT SP 2416 may transmit frames with any TID during the remainder of r-TWT SP 2416. This may result in an unfair situation in which STA 2413 may have to defer channel access till the end of r-TWT SP 2416, while STAs 2411 and 2412 may access the channel freely due to early r-TWT SP termination.

Embodiments, as further described below, provide termination schemes of an r-TWT SP that reduce channel access unfairness among STAs during the r-TWT SP. For example, embodiments address the unfairness situations that may arise as described above in FIGS. 23 and 24.

Embodiments also recognize that an EHT STA that is scheduled in a r-TWT SP may not use the allocated r-TWT SP for various reasons, resulting in the allocated r-TWT SP being wasted. For example, an r-TWT SP may not be used by an r-TWT scheduled STA in the following example situations:
when the r-TWT scheduled STA in power saving mode does not wake up to receive a beacon frame that includes a TWT element indicating the r-TWT SP;
when the r-TWT scheduled STA fails to decode a beacon frame that includes a TWT element indicating the r-TINT SP;
when the r-TWT scheduled STA receiving a beacon frame that includes a TWT element indicating the r-TWT SP detects that the medium is busy for a long period from the start of the r-TWT STA, resulting in the STA not responding with any frame to a trigger frame (e.g., a basic trigger frame, a buffer status report poll trigger frame, a multi-user request to send frame, a request to send frame, etc.) sent from an AP.

In an example embodiment, an AP may transmit a first frame indicating an r-TWT SP for one or more STAs. The first frame may further indicate one or more TIDs of medium access control (MAC) service data units (MSDUs) or aggregated MSDUs (A-MSDUs) with latency sensitive traffic associated with the r-TWT SP. The AP may determine that a wireless medium is not used by the one or more STA within the r-TWT SP. For example, the AP may determine that a wireless medium is not used by the one or more STA within a first time period during the r-TWT SP. Based on the determining, the AP may transmit a second frame indicating termination of the r-TWT SP.

In an example embodiment, an AP may send the second frame indicating termination of the r-TWT SP to STAs. Early termination of the r-TWT SP by the second frame may allow the STAs and the AP to transmit any data frames when the wireless medium is not used for latency sensitive traffic during the r-TWT SP. This may increase channel utilization.

In an example embodiment, a STA may receive a first frame from an AP STA indicating a r-TWT SP and one or more TIDs of medium access control (MAC) service data units (MSDUs) or aggregated MSDUs (A-MSDUs) with latency sensitive traffic associated with the r-TWT SP. The STA may receive a second frame indicating termination of the r-TWT SP during the r-TWT SP. The STA may terminate the r-TWT SP.

In an example embodiment, based on receiving of the second frame, a STA may terminate an r-TWT SP. The STA that has terminated the r-TWT SP may transmit a data frame with any TID (e.g., different from one or more TIDs associated with the r-TWT SP) before the r-TWT SP indicated in the first frame ends. This mechanism may increase channel utilization and increase overall radio link throughput.

In an example embodiment, the first frame may be a beacon frame or a probe response frame. In an example embodiment, the first frame may be a broadcast frame. In an example embodiment, the beacon frame may be transmitted periodically. In an example embodiment, the first frame may comprise a TWT element, where the TWT element indicates the r-TWT SP and the one or more TIDs of latency sensitive traffic.

In an example embodiment, the r-TWT SP may be a period of time during which the one or more STAs are awake to transmit and/or receive MSDUs or A-MSDUs with the one or more TIDs indicated as latency sensitive traffic in the first frame. In an example embodiment, the first frame may comprise r-TWT traffic information comprising at least one bitmap indicating the one or more TIDs which are identified by the AP STA or a non-AP STA as latency sensitive traffic streams; a TWT wake interval mantissa; a TWT wake interval exponent, wherein an interval between two subsequent rTWT SPs is determined based on the TWT wake interval mantissa and the TWT wake interval exponent; a target wake time indicating a timing synchronization function (TSF) at the beginning of a r-TWT SP; and a nominal minimum TWT wake duration indicating the r-TWT SP.

In an example embodiment, the at least one bitmap comprises a first bitmap indicating one or more first TIDs for downlink traffic; and a second bitmap indicating one or more second TIDs for uplink traffic. In an example embodiment, the first frame may indicate scheduling information of one or more r-TWTs comprising the r-TWT SP. In an example embodiment, the TID may indicate a priority of an MSDU by identifying traffic categories (TCs) and traffic streams (TSs).

In an example embodiment, the one or more TIDs indicated as latency sensitive traffic in the first frame comprises one or more first TIDs for downlink traffic and one or more second TIDs for uplink traffic. In an example embodiment, an AP and a STA are allowed to transmit MSDUs or A-MSDUs with the TIDs indicated as latency sensitive traffic in the first frame during the r-TWT SP.

In an example embodiment, a STA is not allowed to transmit MSDUs or A-MSDUs with a TID different from the one or more TIDs indicated as latency sensitive traffic in the first frame, using enhanced distributed channel access (EDCA) during the r-TWT SP. This may reduce contention for channel access among STAs during an r-TWT SP by not allowing EDCA based uplink transmission of non-latency sensitive traffic. A STA may be provided with better quality of service for latency sensitive traffic by the STA transmitting and receiving latency sensitive traffic with high priority during the r-TWT SP.

In an example embodiment, a STA is allowed to transmit MSDUs or A-MSDUs with a TID different from the one or more TI Ds indicated as latency sensitive traffic in the first frame, in response to a trigger frame received from an AP during the r-TWT SP. A trigger frame may be sent by an AP to schedule uplink multi-user transmissions from one or more STAs using uplink OFDMA (orthogonal frequency division multiple access) and/or uplink MU-MI MO (multi-user multiple input multiple output). The trigger frame allocates resources for and solicits one or more high efficiency trigger based physical protocol data unit (HE TB PPDU) transmissions from one or more STAs. The trigger frame includes necessary information for STAs to transmit an HE TB PPDU, for example a type of trigger frame indicating a type of frame (e.g., a data frame, a CTS frame, a BA frame, a buffer status report frame, etc.) to be sent in an HE TB PPDU, one or more identifiers of STAs who transmit HE TB PPDU in response to the trigger frame, frequency resource information (e.g., bandwidth, resource unit, etc.), time resource information (e.g., a length of HE TB PPDU), spatial resource information (e.g., spatial stream allocation), modulation and coding scheme information, etc.

In an example embodiment, during an r-TWT SP, an AP may transmit a trigger frame to schedule uplink transmissions from STAs, with high priority, that have uplink buffered data frames with TIDs indicated as latency sensitive traffic, and at the same time the trigger frame may trigger transmission of an HE TB PPDU from a STA that has no latency sensitive traffic but has buffered latency tolerant traffic. To increase channel utilization, during an r-TWT SP, the STA that has no uplink buffered latency sensitive traffic but has uplink buffered non-latency sensitive traffic may be allowed to transmit, in response to the trigger frame, an HE TB PPDU including MSDUs or A-MSDUs with a TID different from the one or more TI Ds indicated as latency sensitive traffic in the first frame.

In an example embodiment, an AP and a STA are allowed to transmit MSDUs or A-MSDUs with any TIDs outside the r-TWT SP. In an example embodiment, a STA may end a TXOP prior to the r-TWT SP based on the first frame.

In example embodiments, the second frame may be a broadcast frame. The second frame may be at least one of a control frame, a CF-End frame, a QoS data frame, and a QoS null frame. In an example embodiment, the QoS null frame and the QoS data frame may comprise at least one of an aggregated control (A-Control) field indicating termination of r-TWT SP and a QoS Control field with an end of service period (EOSP) field set to 1. In an example embodiment, the control frame may comprise a field indicating termination of an r-TWT SP.

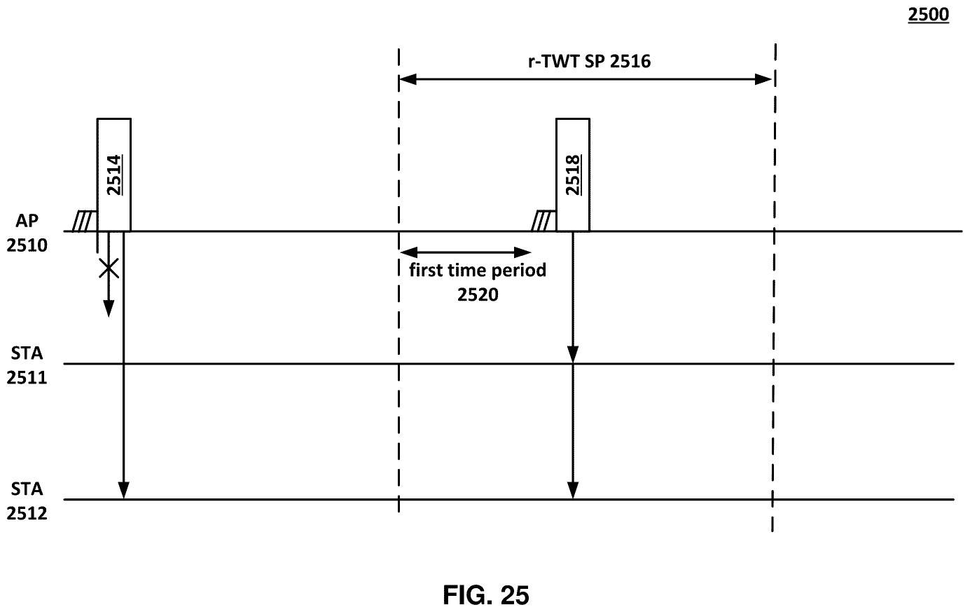

FIG. 25 illustrates an example 2500 of r-TWT operation according to an embodiment. As shown in FIG. 25, example 2500 includes an AP 2510 and STAs 2511 and 2512. In an example, AP 2510 may be a TWT scheduling AP. AP 2510 may transmit a frame 2514 including a TWT element. Frame 2514 may be a beacon frame or a TWT setup response frame, for example. The TWT element may indicate a r-TWT SP 2516 of an r-TWT. The TWT element may indicate one or more TI Ds of latency sensitive traffic associated with the r-TWT.

In an example, STA 2511 may be a member TWT scheduled STA of the r-TWT, while STA 2512 may be a non-member of the r-TWT. In an example, STA 2511 may have buffered uplink latency sensitive traffic to transmit to AP 2510 and/or buffered downlink latency sensitive traffic to receive from AP 2510 during r-TWT SP 2516.

In an example, STA 2511 may not receive frame 2514 from AP 2510, while STA 2512 may receive frame 2514 from AP 2510. Due to not receiving frame 2514, STA 2511 may not transmit latency sensitive traffic when r-TWT SP 2516 begins. As a non-member of the r-TWT, STA 2512 may also not transmit at least latency sensitive traffic during r-TWT SP 2516.

AP 2510 may determine that the wireless medium is not being used during a first time period 2520 of r-TWT SP 2516. Based on this determination, AP 2510 may send a frame 2518 indicating termination of r-TWT SP 2516. STA 2511 and/or STA 2512 receiving frame 2518 may terminate r-TWT SP 1420 based on frame 2518.

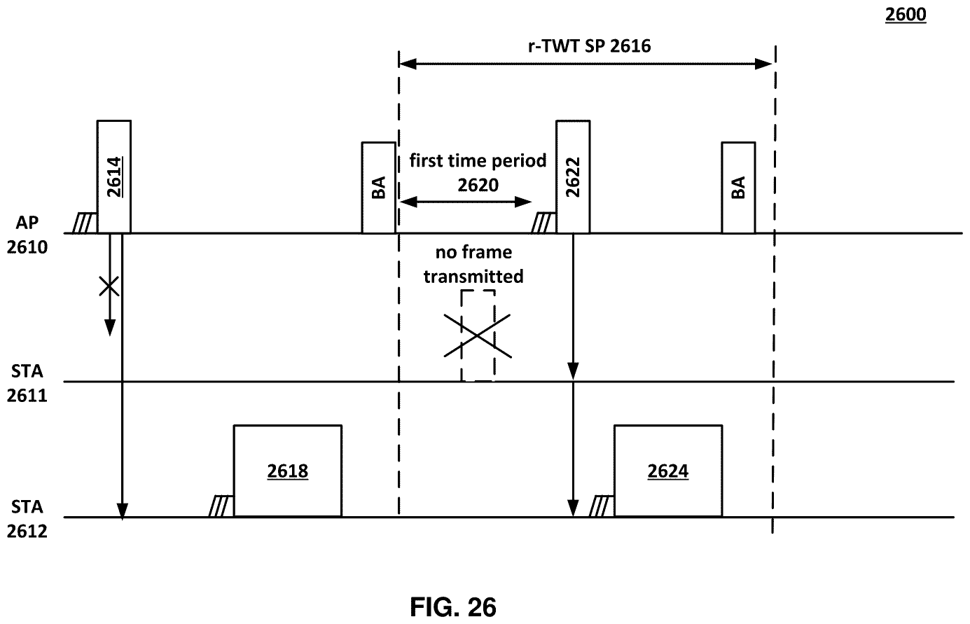

FIG. 26 illustrates an example 2600 of r-TWT operation according to an embodiment. As shown in FIG. 26, example 2600 includes an AP 2610 and STAs 2611 and 2612. In an example, AP 2610 may be a TWT scheduling AP. AP 2610 may transmit a frame 2614 including a TWT element. Frame 2614 may be a beacon frame or a TWT setup response frame, for example. The TWT element may indicate a r-TWT SP 2616 of an r-TWT. The TWT element may indicate one or more TIDs of latency sensitive traffic associated with the r-TWT.

In an example, STA 2611 may be a member TWT scheduled STA of the r-TWT, while STA 2612 may be a non-member of the r-TWT. In an example, STA 2611 may have buffered uplink latency sensitive traffic to transmit to AP 2610 and/or buffered downlink latency sensitive traffic to receive from AP 2610 during r-TWT SP 2616.

In an example, prior to the start of r-TWT SP 2616, STA 2612 may transmit a frame 2618 to AP 2610. Frame 2618 may comprise any TID (e.g., an MSDU or an A-MSDU with a TID that is or is not identified by frame 2614 as latency sensitive traffic). STA 2612 may stop transmitting frame 2618 prior to the start of r-TWT SP 2616. STA 2612 may defer EDCA channel access for transmission of frame 2618 to the end of r-TWT SP 2616.

In an example, STA 2611 may not receive frame 2614 from AP 2610, while STA 2612 may receive frame 2614 from AP 2610. Due to not receiving frame 2614, STA 2611 may not transmit latency sensitive traffic when r-TWT SP 2616 begins. As a non-member of the r-TWT, STA 2612 may also not transmit at least latency sensitive traffic during r-TWT SP 2616.

AP 2610 may determine that the wireless medium is not being used during a first time period 2620 of r-TWT SP 2616. Based on this determination, AP 6510 may send a frame 2622 indicating termination of r-TWT SP 2616. Frame 2622 may be transmitted to STAs that belong to a BSS of AP 2610. STA 2611 and/or STA 2612 receiving frame 2622 may terminate r-TWT SP 2616 based on frame 2622.

In an embodiment, AP 2610 may determine that the wireless medium is not being used during first time period 2620 when a frame of a specific type is not received by AP 2610 during first time period 2620. The frame of a specific type may be an MSDU with a TID indicated as latency sensitive traffic in frame 2614, a request to send (RTS) frame, a power save poll (PS-Poll) frame, or a QoS null frame, for example. In an embodiment, the frame of a specific type may be a frame that would have been received from a member TWT scheduled STA (e.g., STA 2611) of the r-TWT.

Upon terminating r-TWT SP 2616 based on frame 2622, STA 2612 may transmit a frame 2624 to AP 2610. Frame 2624 may be a control frame, any management frame, and/or an MSDU or A-MSDU with any TID. Frame 2624 frame may be transmitted using EDCA. AP 2610 may acknowledge frame 2624 by transmitting a BA frame to STA 2612.

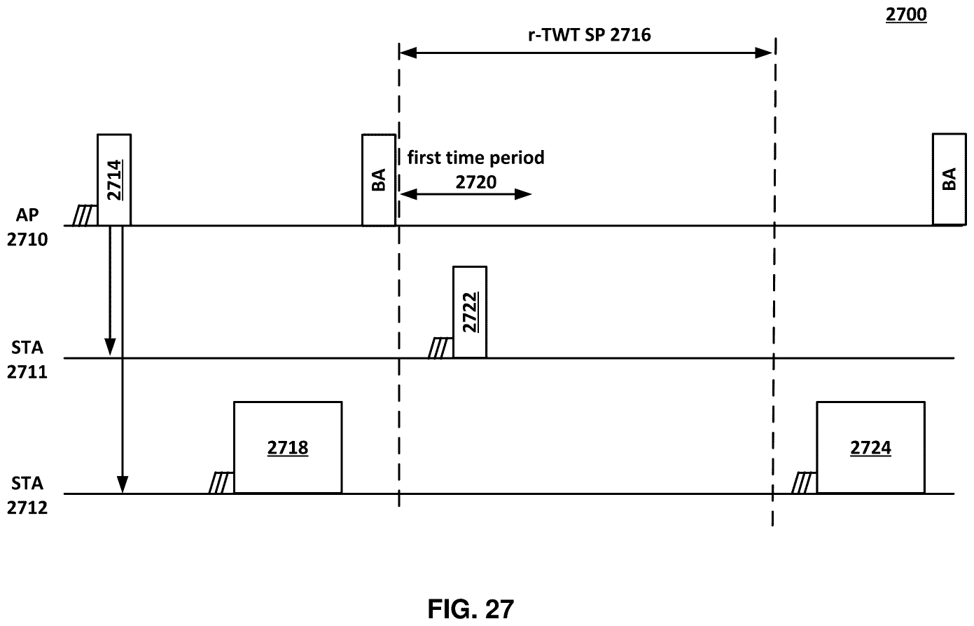

FIG. 27 illustrates an example 2700 of r-TWT operation according to an embodiment. As shown in FIG. 27, example 2700 includes an AP 2710 and STAs 2711 and 2712. In an example, AP 2710 may be a TWT scheduling AP. AP 2710 may transmit a frame 2714 including a TWT element. Frame 2714 may be a beacon frame or a TWT setup response frame, for example. The TWT element may indicate a r-TWT SP 2716 of an r-TWT. The TWT element may indicate one or more TIDs of latency sensitive traffic associated with the r-TWT.

In an example, STA 2711 may be a member TWT scheduled STA of the r-TWT, while STA 2712 may be a non-member of the r-TWT. In an example, STA 2711 may have buffered uplink latency sensitive traffic to transmit to AP 2710 and/or buffered downlink latency sensitive traffic to receive from AP 2710 during r-TWT SP 2716.

In an example, prior to the start of r-TWT SP 2716, STA 2712 may transmit a frame 2718 to AP 2710. Frame 2718 may comprise any TID (e.g., an MSDU or an A-MSDU with a TID that is or is not identified by frame 2714 as latency sensitive traffic). STA 2712 may stop transmitting frame 2718 prior to the start of r-TWT SP 2716. STA 2712 may defer EDCA channel access for transmission of frame 2718 to the end of r-TWT SP 2716.

In an example, STA 2711 receives frame 2714 from AP 2710. As a member of the r-TWT, STA 2711 may transmit a frame 2722 during a first time period 2720 of r-TWT SP 2716. In an example, AP 2710 may determine that the wireless medium is used based on receiving frame 2722 from STA 2711. In an embodiment, AP 2710 may determine that the wireless medium is being used during first time period 2720 when a frame of a specific type is received by AP 2710 during first time period 2720. The frame of a specific type may be an MSDU with a TID indicated as latency sensitive traffic in frame 2714, a request to send (RTS) frame, a power save poll (PS-Poll) frame, or a QoS null frame, for example. Based on determining that the wireless medium is used during first time period 2720 of r-TWT SP 2716, AP 2710 may maintain r-TWT SP 2716.

When r-TWT SP 2716 ends, STA 2712 may access the medium to transmit a frame 2724 to AP 2710 and may receive a BA frame in response from AP 2710. Frame 2724 may be any control frame, any management frame, and/or an MSDU or A-MSDU with any TID. Frame 2724 may be transmitted using EDCA.

In accordance with embodiments, the first time period of the r-TWT SP may start from the beginning of the r-TWT SP, during the r-TWT SP, or after a pre-determined time after the beginning of the r-TWT SP. In an example embodiment, the first time period may be an r-TWT carrier sense duration (CSD). In an example, the first time period may be set to a value of 1/N times of a quiet interval, wherein the quiet interval is one time unit (TU) and N is a constant positive integer. In an example, the first time period may be based on a duration calculated by one or more EDCA channel access parameters for a TID of the one or more TIDs. For example, the first time period may be based on an AIFS plus a CWmin of an AC, wherein the CWmin is minimum contention window for the AC associated with the TID, plus an RTS frame transmission time.

In an example embodiment, the quiet interval may be a period during which a plurality of STAs may send no messages and no signals associated with IEEE 802.11 standard technologies in one or more frequency bands.

In an example embodiment, AP 2710 may further determine that the wireless medium is used during r-TWT SP 2716 based on at least one of: a PHY-RXSTART. Indication being received, and a frame being received from a STA belonging to a BSS of the AP during the first time period.

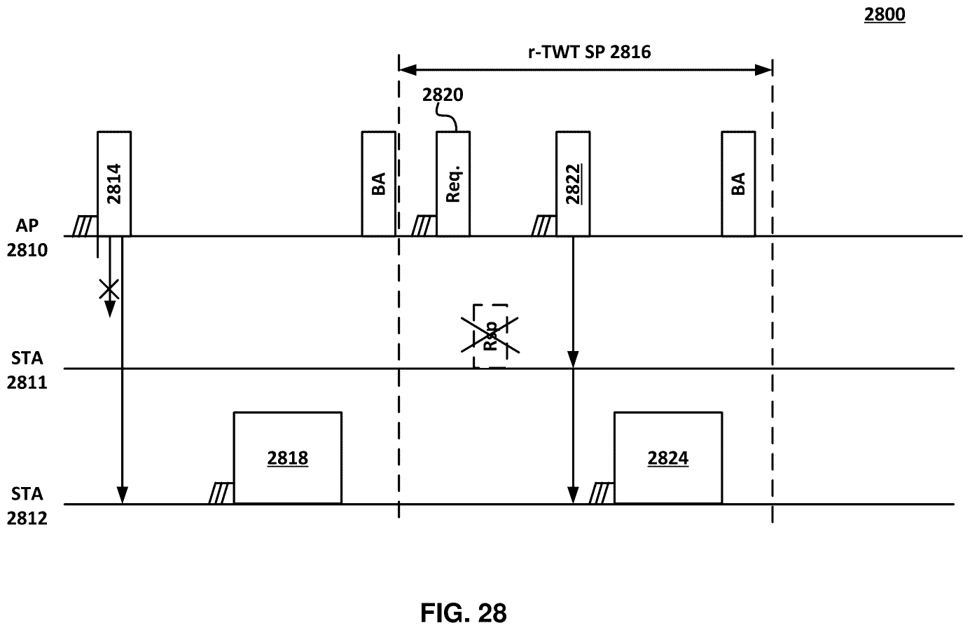

FIG. 28 illustrates an example 2800 of r-TWT operation according to an embodiment. As shown in FIG. 28, example 2800 includes an AP 2810 and STAs 2811 and 2812. In an example, AP 2810 may be a TWT scheduling AP. AP 2810 may transmit a frame 2814 including a TWT element. Frame 2814 may be a beacon frame or a TWT setup response frame, for example. The TWT element may indicate a r-TWT SP 2816 of an r-TWT. The TWT element may indicate one or more TIDs of latency sensitive traffic associated with the r-TWT.

In an example, STA 2811 may be a member TWT scheduled STA of the r-TWT, while STA 2812 may be a non-member of the r-TWT. In an example, STA 2811 may have buffered uplink latency sensitive traffic to transmit to AP 2810 and/or buffered downlink latency sensitive traffic to receive from AP 2810 during r-TWT SP 2816.

In an example, prior to the start of r-TWT SP 2816, STA 2812 may transmit a frame 2818 to AP 2810. Frame 2818 may comprise any TID (e.g., an MSDU or an A-MSDU with a TID that is or is not identified by frame 2814 as latency sensitive traffic). STA 2812 may stop transmitting frame 2818 prior to the start of r-TWT SP 2816. STA 2812 may defer EDCA channel access for transmission of frame 2818 to the end of r-TWT SP 2816.

In an example, STA 2811 may not receive frame 2814 from AP 2810, while STA 2812 may receive frame 2814 from AP 2810. Due to not receiving frame 2814, STA 2811 may not transmit latency sensitive traffic when r-TWT SP 2816 begins. As a non-member of the r-TWT, STA 2812 may also not transmit at least latency sensitive traffic during r-TWT SP 2816.

In an example, AP 2810 may transmit a request frame 2820 to STA 2811 during r-TWT SP 2816. Request frame 2820 may be a trigger frame. The trigger frame may be at least one of a buffer status report poll (BSRP) trigger frame, a null data packet (NDP) feedback report poll (NFRP) trigger frame, a multi-user request to send (MU-RTS) trigger frame, a basic trigger frame, or a new type of trigger frame.

STA 2811 may not respond to request frame 2820. In an embodiment, AP 2810 may determine that the wireless medium is not being used based on not receiving a response frame from STA 2811 in response to request frame 2820. The response frame may be at least one of a QoS null frame, a null data packet (NDP) frame, a clear to send (CTS) frame, and a power save poll (PS-Poll) frame. In an embodiment, AP 2810 may determine that the wireless medium is not being used when a response frame from STA 2811 is not received within a predetermined duration from the transmission of request frame 2820.

Upon determining that the wireless medium is not being used, AP 2810 may transmit a frame 2822 indicating termination of r-TWT SP 2816. Frame 2822 may be transmitted to STAs that belong to a BSS of AP 2810. STA 2811 and/or STA 2812 receiving frame 2822 may terminate r-TWT SP 2816 based on frame 2822.

Upon terminating r-TWT SP 2816 based on frame 2822, STA 2812 may transmit a frame 2824 to AP 2610. Frame 2824 may be a control frame, any management frame, and/or an MSDU or A-MSDU with any TID. Frame 2824 frame may be transmitted using EDCA. AP 2810 may acknowledge frame 2824 by transmitting a BA frame to STA 2812.

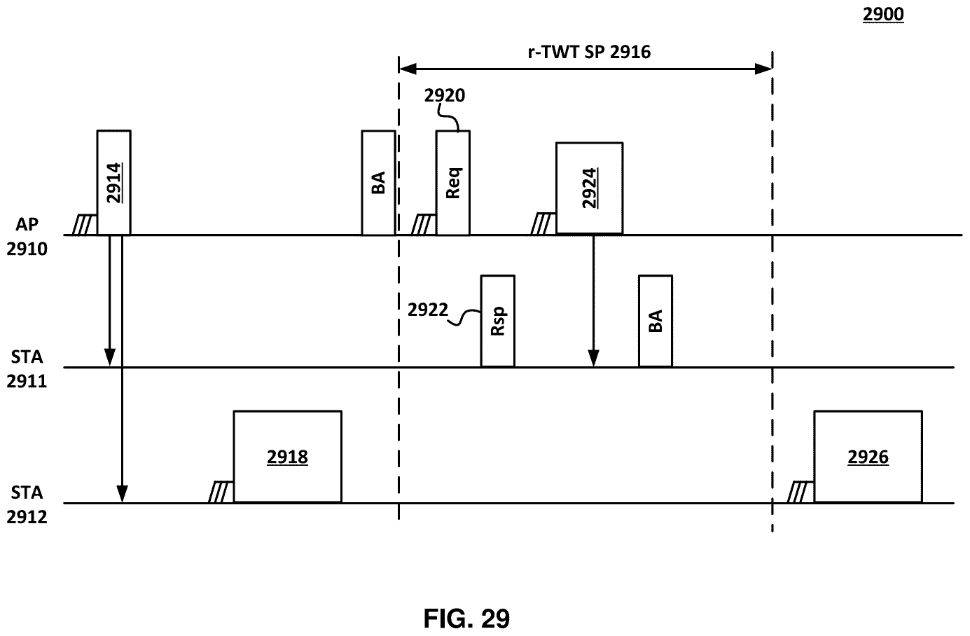

FIG. 29 illustrates an example 2900 of r-TWT operation according to an embodiment. As shown in FIG. 29, example 2900 includes an AP 2910 and STAs 2911 and 2912. In an example, AP 2910 may be a TWT scheduling AP. AP 2910 may transmit a frame 2914 including a TWT element. Frame 2914 may be a beacon frame or a TWT setup response frame, for example. The TWT element may indicate a r-TWT SP 2916 of an r-TWT. The TWT element may indicate one or more TIDs of latency sensitive traffic associated with the r-TWT.

In an example, STA 2911 may be a member TWT scheduled STA of the r-TWT, while STA 2912 may be a non-member of the r-TWT. In an example, STA 2911 may have buffered uplink latency sensitive traffic to transmit to AP 2910 and/or buffered downlink latency sensitive traffic to receive from AP 2910 during r-TWT SP 2916.

In an example, prior to the start of r-TWT SP 2916, STA 2912 may transmit a frame 2918 to AP 2910. Frame 2918 may comprise any TID (e.g., an MSDU or an A-MSDU with a TID that is or is not identified by frame 2914 as latency sensitive traffic). STA 2912 may stop transmitting frame 2918 prior to the start of r-TWT SP 2916. STA 2912 may defer EDCA channel access for transmission of frame 2918 to the end of r-TWT SP 2916.

In an example, STAs 2911 and 2912 receive frame 2914 from AP 2910. In an example, AP 2910 may transmit a request frame 2920 to STA 2911 during r-TWT SP 2916. Request frame 2920 may be a trigger frame. The trigger frame may be at least one of a buffer status report poll (BSRP) trigger frame, a null data packet (NDP) feedback report poll (NFRP) trigger frame, a multi-user request to send (MU-RTS) trigger frame, a basic trigger frame, or a new type of trigger frame.

STA 2911 may respond to request frame 2820 by transmitting a response frame 2922. In an embodiment, AP 2910 may determine that the wireless medium is being used based on receiving response frame 2922 from STA 2911 in response to request frame 2920. Response frame 2922 may be at least one of a QoS null frame, a null data packet (NDP) frame, a clear to send (CTS) frame, and a power save poll (PS-Poll) frame. In an embodiment, AP 2910 may determine that the wireless medium is being used when response frame 2922 is received within a predetermined duration from the transmission of request frame 2920.

Based on determining that the wireless medium is being used, AP 2910 may maintain r-TWT SP 2916. In an example, AP 2910 may transmit a data frame 2924 comprising a TID associated with the r-TWT and may receive a BA frame from STA 2911.

When r-TWT SP 2916 ends, STA 2912 may access the medium to transmit a frame 2926 to AP 2910. Frame 2926 may be any control frame, any management frame, and/or an MSDU or A-MSDU with any TID. Frame 2724 may be transmitted using EDCA.

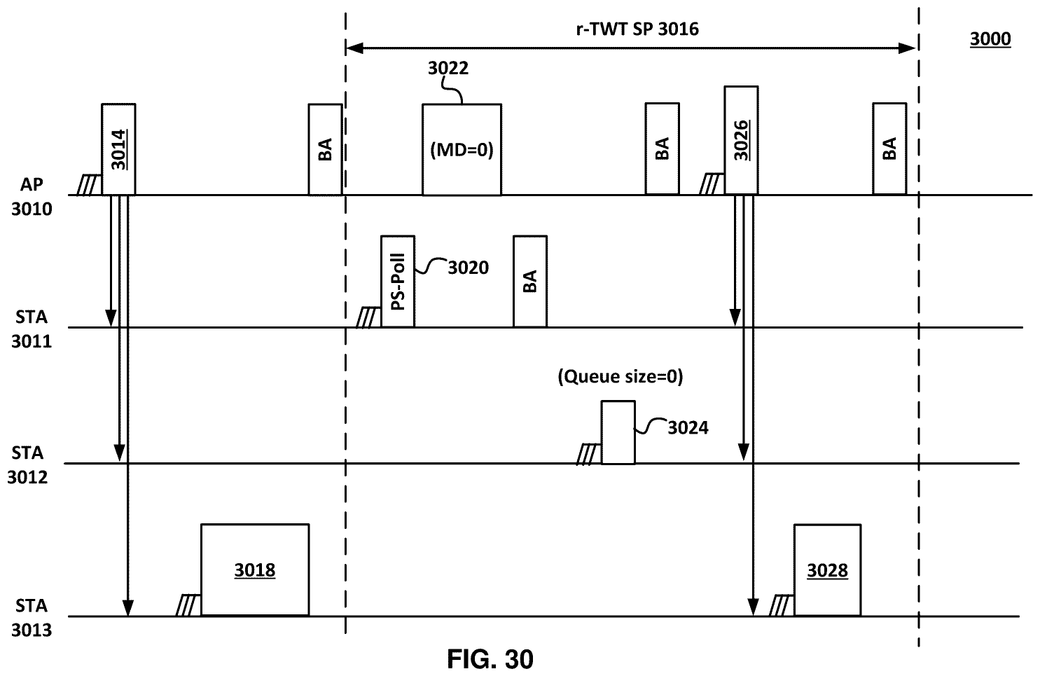

FIG. 30 illustrates an example 3000 of r-TWT operation according to an embodiment. As shown in FIG. 30, example 3000 includes an AP 3010 and STAs 3011, 3012, and 3013. In an example, AP 3010 may be a TWT scheduling AP. AP 3010 may transmit a frame 3014 including a TWT element. Frame 3014 may be a beacon frame or a TWT setup response frame, for example. The TWT element may indicate a r-TWT SP 3016 of an r-TWT. The TWT element may indicate one or more TI Ds of latency sensitive traffic associated with the r-TWT.

In an example, STAs 3011 and 3012 may be member TWT scheduled STAs of the r-TWT, while STA 3013 may be a non-member of the r-TWT. In an example, STA 3011 and/or STA 3012 may have buffered uplink latency sensitive traffic to transmit to AP 2910 and/or buffered downlink latency sensitive traffic to receive from AP 2910 during r-TWT SP 2916.

In an example, prior to the start of r-TWT SP 3016, STA 3013 may transmit a frame 3018 to AP 3010. Frame 3018 may comprise any TID (e.g., an MSDU or an A-MSDU with a TID that is or is not identified by frame 3014 as latency sensitive traffic). STA 3013 may stop transmitting frame 3018 prior to the start of r-TWT SP 3016. STA 3013 may defer EDCA channel access for transmission of frame 3018 to the end of r-TWT SP 3016.

In an example, STAs 3011, 3012, and 3013 receive frame 3014 from AP 3010. In an example, AP 3010 may receive a PS-Poll frame 3020 from STA 3011 during r-TWT SP 3016. AP 3010 may respond to PS-Poll frame 3020 by transmitting a frame 3022 to STA 3011 comprising a TID associated the r-TWT. Frame 3022 may have a more data (MD) field set to 0 indicating no further buffered downlink traffic for STA 3011. Subsequently, AP 3010 may receive from STA 3012 a frame 3024 comprising a TID associated with the r-TWT. Frame 3024 may have a queue size field (of a QoS control field) set to 0.

In an example, after receiving frame 3024 from STA 3012, AP 3010 may determine that there is no more buffered uplink or downlink latency-sensitive traffic (i.e., having a TID associated with the r-TWT) for transmission from/to member STAs 3011 and 3012. In an embodiment, the determination by AP 3010 may be based on transmitting frame 3022 having an MD field set to 0 and/or receiving frame 3024 having a queue size field set to 0. Based on this determination, AP 3010 may transmit a frame 3026 indicating termination of r-TWT SP 3016. Frame 3026 may be transmitted to STAs that belong to a BSS of AP 3010. STA 3011, 3012, and/or 3013 receiving frame 3026 may terminate r-TWT SP 3016 based on frame 3026.

In an example embodiment, frame 3026 may be a broadcast frame that can be received by r-TWT scheduled STAs and non-r-TWT scheduled STAs. Frame 3026 may be a control frame, a CF-End frame, a QoS null frame, or a QoS data frame. In an example embodiment, the QoS null frame or the QoS data frame may comprise at least one of an aggregated control (A-Control) field indicating termination of the r-TWT SP and a QoS Control field with an end of service period (EOSP) field set to 1.

Upon terminating r-TWT SP 3016 based on frame 3026, STA 3013 may transmit a frame 3028 to AP 3010. Frame 3028 may be a control frame, any management frame, and/or an MSDU or A-MSDU with any TID. Frame 3028 frame may be transmitted using EDCA. AP 3010 may acknowledge frame 3028 by transmitting a BA frame to STA 3013.

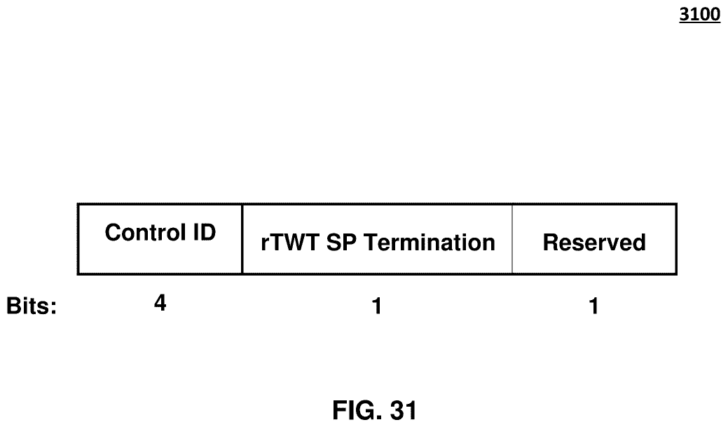

FIG. 31 illustrates an example aggregated control field 3100 which may be used to indicate termination of an r-TWT SP. As shown in FIG. 311, aggregated control field 3100 may include a Control ID subfield, an rTWT SP Termination field, and Reserved field. The Control ID subfield may indicate a type of information carried (e.g., TTSP: Termination of r-TWT Service Period). The r-TWT SP Termination subfield may be set to 1 to indicate termination of a r-TWT SP.

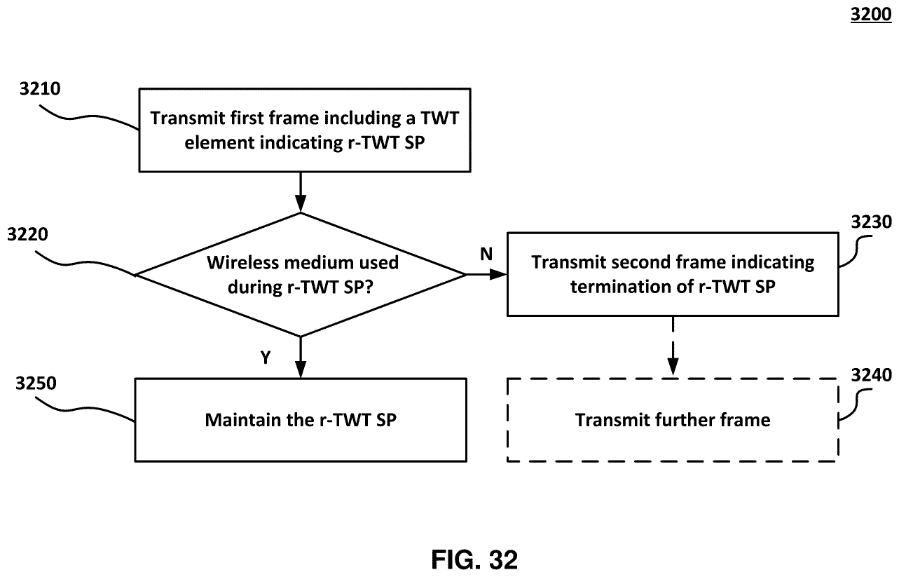

FIG. 32 illustrates an example process 3200 for r-TWT operation according to an embodiment. Example process 3200 is provided for the purpose of illustration and is not limiting of embodiments. Process 3200 may be performed by an AP.

As shown in FIG. 32, process 3200 begins in step 3210, which includes transmitting a first frame including a TWT element indicating a r-TWT SP. The TWT element may further indicate one or more TIDs of latency sensitive traffic that are allowed to be transmitted during the r-TWT SP.

Next, in step 3220, process 3200 may include determining whether a wireless medium is being used by STAs during the r-TWT SP. In an embodiment, the AP may determine that the wireless medium is or is not being used based on receiving or not receiving a third frame during a first time period within the r-TWT SP. Alternatively or additionally, the AP may determine that the wireless medium is or is not being used based on receiving or not receiving a response frame from a STA in response to a request frame transmitted by the AP within the r-TWT SP. In an example, the third frame may be an MSDU with a TID indicated as latency sensitive traffic in the first frame, a request to send (RTS) frame, a power save poll (PS-Poll) frame, or a QoS null frame. In an example, the request frame may be a buffer status report poll (BSRP) trigger frame, a null data packet (NDP) feedback report poll (NFRP) trigger frame, a multi-user request to send (MU-RTS) trigger frame, a basic trigger frame, or a new type of trigger frame. In an example, the response frame may be a QoS null frame, a null data packet (NDP) frame, a clear to send (CTS) frame, or a power save poll (PS-Poll) frame.

If the AP determines in step 3220 that the wireless medium is being used, process 3200 proceeds to step 3250, which includes maintaining the r-TWT SP. Otherwise, process 3200 proceeds to step 3230.

In step 3230, process 3200 may include transmitting a second frame indicating termination of the r-TWT SP to STAs that belong to a BSS of the AP. In an example, the second frame may be a control frame, a CF-End frame, a QoS data frame, and a QoS null frame.

Subsequently, process 3200 may proceed to step 3240, in which after transmitting the second frame indicating termination of the r-TWT SP, the AP may send a further frame to a STA. The further frame may be any control frame, any management frame, or an MSDU with any TID.

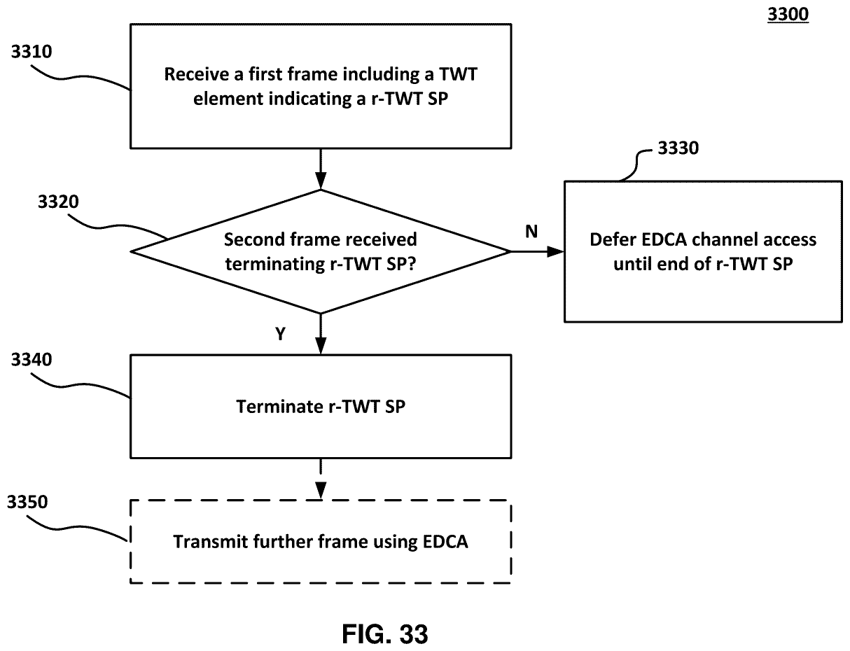

FIG. 33 illustrates an example process 3300 for r-TWT operation according to an embodiment. Example process 3300 is provided for the purpose of illustration only and is not limiting of embodiments. Example process 3300 may be performed by STA. The STA may be a non-r-TWT scheduled STA.

As shown in FIG. 33, process 3300 begins in step 3310, which includes receiving a first frame including a TWT element indicating a r-TWT SP. The TWT element may further indicate one or more TIDs of latency sensitive traffic that are allowed to be transmitted during the r-TWT SP.

Next, in step 3320, process 3300 may include determining whether a second frame terminating the r-TWT SP has been received during the r-TWT SP. If the answer is no, process 3300 proceeds to step 3330, which may include deferring EDCA channel access until the end of the r-TWT SP. In an embodiment, the STA may defer EDCA channel access when the STA does not have buffered uplink latency sensitive traffic associated with the r-TWT. Otherwise, process 3300 proceeds to step 3340, which may include terminating the r-TWT SP. Subsequently, process 3300 may proceed to step 3350, which may include transmitting a further frame using EDCA. The further frame may be any control frame, any management frame, or an MSDU with any TID.

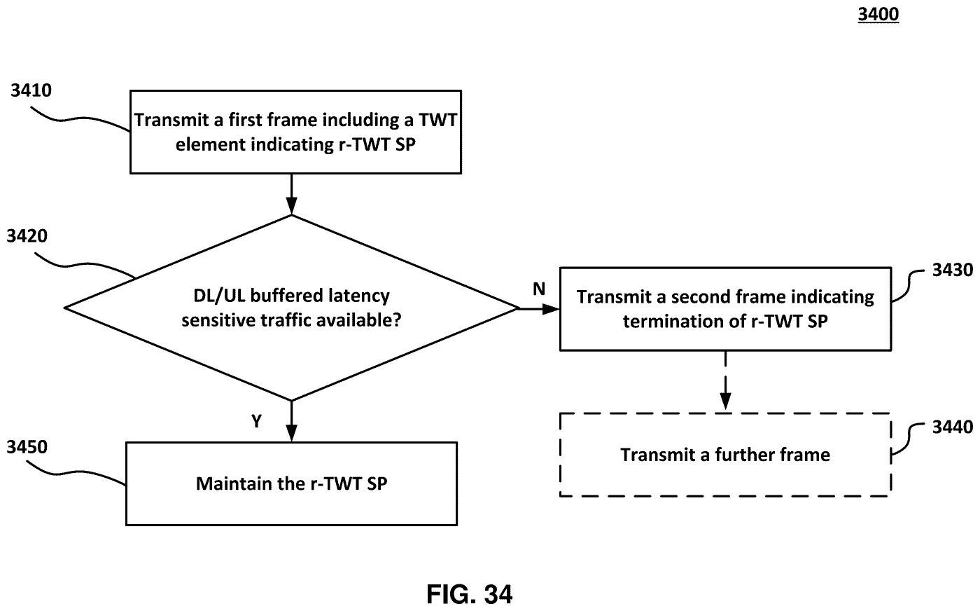

FIG. 34 illustrates an example process 3400 for r-TWT operation according to an embodiment. Example process 3400 is provided for the purpose of illustration only and is not limiting of embodiments. Example process 3400 may be performed by an AP.

As shown in FIG. 34, process 3400 begins in step 3410, which may include transmitting a first frame including a TWT element indicating a r-TWT SP. The TWT element may further indicate one or more TIDs of latency sensitive traffic that are allowed to be transmitted during the r-TWT SP.

Next, in step 3420, process 3400 may include determining whether DL/UL buffered latency sensitive traffic (i.e., comprising a TID associated with the r-TWT) is available for transmission during the r-TWT SP. In an embodiment, the AP may determine that no UL buffered latency sensitive traffic is available for transmission during the r-TWT SP based on receiving from a STA an uplink data frame with a queue size field set to 0 and/or a more data field set to 0 for TID(s) associated with the r-TWT. In an embodiment, the AP may determine that no DL buffered latency sensitive traffic is available for transmission during the r-TWT SP based on transmitting a downlink data frame with a more data field set to 0 for TID(s) associated with the r-TWT.

If, in step 3420, it is determined that DL/UL buffered latency sensitive traffic is available for transmission during the r-TWT SP, process 3400 may proceed to step 3450, which may include maintaining the r-TWT SP. Otherwise, process 3400 may proceed to step 3430, which may include transmitting a second frame indicating termination the r-TWT SP. The second frame may be transmitted to r-TWT scheduled STAs and/or non-r-TWT scheduled STAs that belong to a BSS of the AP. In an example, the second frame may be a control frame, a CF-End frame, a QoS data frame, and a QoS null frame.

Subsequently, after terminating the r-TWT SP in step 3430, process 3400 may proceed to step 3440, which may include transmitting a further frame to a STA. The STA may be a member or a non-member of the r-TWT. The further frame may be any control frame, any management frame, or an MSDU with any TID.

Further example embodiments in accordance with the present disclosure are presented below.

In an example embodiment, a STA may receive, from an access point (AP), a first frame indicating a trigger-enabled r-TWT SP for one or more STAs comprising the STA.

Based on not receiving a second frame from the AP during a first time period within the trigger-enabled r-TWT SP, the STA may transmit a non-trigger based frame following the first time period.

The STA may be configured to receive a trigger frame from the AP before transmitting during the trigger-enabled r-TWT SP.

The transmitting the non-trigger based frame by the STA may terminate the trigger-enabled r-TWT SP. The non-trigger based frame may be a frame that is transmitted using a contention based channel access scheme. The contention based channel access scheme may be a distribute coordination function (DCF) scheme, an enhanced distributed channel access (EDCA) scheme, or a listen before talk (LBT) scheme.

In an example, the second frame may be a data frame, a control frame, a management frame, or an action frame. In an example, the second frame is a trigger frame. In an example, the second frame is any frame in accordance with the IEEE 802.11 standard.

The STA may transmit, to the AP, a setup request frame indicating one or more first TIDs associated with the trigger-enabled r-TWT SP. The STA may receive, from the AP, a setup response frame indicating one or more second TIDs associated with the trigger-enabled r-TWT SP in order to set up the trigger-enabled r-TWT SP. The first TIDs may be different from the second TIDs. The setup response frame may be in response to the setup request frame. The first or second TIDs may identify latency sensitive traffic for transmission during the trigger-enabled r-TWT SP. The STA may be a member of the trigger-enabled r-TWT SP indicated in the setup response frame. The setup request frame may be a TWT setup request frame. The setup response frame may be a TWT setup response frame.

The trigger-enabled r-TWT SP may be a period of time during which the one or more STAs are awake to transmit and/or receive MSDUs or A-MSDUs carrying traffic with a TID from among the one or more first or second TIDs. A TID of the one or more first or second TIDs may indicate a priority of an MSDU by identifying traffic categories (TCs) and traffic streams (TSs). The setup request frame comprises a bitmap indicating the one or more first TIDs for downlink traffic, and the setup response frame comprises a bitmap indicating the one or more second TIDs for uplink traffic.

The setup request frame or the setup response frame comprise a value of the first time period

The STA may not transmit the non-trigger based frame in response to receiving the second frame from the AP during the first time period.

The first frame may be a beacon frame, a probe response frame, a fast initial link setup (FI LS) discovery frame, a TIM broadcast frame, a TWT Setup frame, or an association response frame. The first frame may be broadcast or individually addressed by the AP. The first frame may comprise a target wake time (TWT) element. The TWT element may indicate scheduling information of the trigger-enabled r-TWT SP. The first frame may be transmitted periodically. The first frame may comprise an address of the AP. A STA may end, based on the first frame, a TXOP prior to the trigger-enabled r-TWT SP.

The first frame may be received by a plurality of STAs. The AP may schedule a quiet interval overlapping with the trigger-enabled r-TWT SP. The duration of the quiet interval may be 1 TU or 1 millisecond. The start time of the quiet interval may be the same as the start time of the r-TWT SP period.

The first frame may comprise a TWT flow identifier identifying the trigger-enabled r-TWT SP among a plurality of TWT SPs.

The AP and the STA may not be allowed to transmit MSDUs or A-MSDUs with any TIDs outside the r-TWT SP.

A value of the first time period may be based on an AIFS plus a CWmin of an AC, wherein the CWmin is minimum contention window for the AC associated with the TID, plus an RTS frame transmission time, plus a SIFS, plus a CTS frame transmission time.

The first time period may start from the beginning of the trigger-enabled r-TWT SP. The first time period may start during the trigger-enabled r-TWT SP. The first time period may start after a pre-determined time after the beginning of the trigger-enabled r-TWT SP. The first time period may be a quiet interval. The first time period may be 1/N times or N times of a quiet interval.

The quiet interval may be one time unit (TU) or one milli-seconds. A value of N may be a constant positive integer. The first frame, transmitted by the AP, may indicate a value of N. The quiet interval may be a period during which a plurality of STAs send no messages and no signals associated with IEEE 802.11 standard technologies in one or more frequency bands.

The first frame may indicate a value of the first time period. The first frame may be a beacon frame, a probe response frame, an association response frame, a TWT Setup frame or an action frame. A TWT element of the first frame may comprise a value of the first time period.

A value of the first time period may be based on an access category of at least one TID of one or more first or second TIDs.

A value of the first time period may be based on a duration calculated by one or more enhanced distributed channel access (EDCA) channel access parameters for a TID of the first or second one or more TIDs.

The first time period may be based on at least one of an AIFS of an AC corresponding to a TID of the first or second one or more TIDs, a CWmin of the AC, a SIFS, an RTS TX time, an CTS TX time, and/or a parameter associated with EDCA.

The transmitting of the non-trigger based frame may occur at a pre-determined time after the first time period ends. The transmitting of the non-trigger based frame may be based on the first time period ending prior to a predetermined time before the end of the trigger-enabled r-TWT SP.

An AP may transmit a first frame indicating a trigger-enabled r-TWT SP for one or more STAs.

The AP may determine that a wireless medium is not used at the start time of the trigger-enabled r-TWT SP based on a carrier sensing result indicating an idle medium. The carrier sensing results indicating the idle medium may be a physical carrier sensing result indicating idle and a virtual carrier sensing result indicating idle. The virtual carrier sensing result indicating idle may be a network allocation vector (NAV) with zero value. A carrier sensing results indicating busy medium may be a physical carrier sensing result indicating busy or a virtual carrier sensing result indicating busy. The virtual carrier sensing result indicating busy may be a network allocation vector (NAV) with non-zero value.

Based on the carrier sensing result indicating idle medium, the AP may transmit a second frame within a first time period.

The AP may determine that the wireless medium is used at the start time of the trigger-enabled r-TWT SP based on a carrier sensing result indicating a busy medium.

Based on the carrier sensing result indicating the busy medium, the AP may not transmit the second frame during the first time period.

The AP may receive, from a STA of the one or more STAs, a non-trigger based frame during the first time period. The non-trigger based frame may be a frame that is transmitted using a contention based channel access scheme. The contention based channel access scheme may be a distribute coordination function (DCF) scheme, an enhanced distributed channel access (EDCA) scheme, or a listen before talk (LBT) scheme.

The one or more STAs may be configured to receive a trigger frame from the AP before transmitting during the trigger-enabled r-TWT SP.

The second frame may be a trigger frame. The second frame may be a data frame, a control frame, a management frame, or an action frame. The second frame may be any frame in accordance with the IEEE 802.11 standard.

The AP may receive, from a STA of the one or more STA, a setup request frame indicating one or more first TI Ds associated with the trigger-enabled r-TWT SP. The AP may transmit, to the STA, a setup response frame indicating one or more second TIDs associated with the trigger-enabled r-TWT SP. The setup response frame may be in response to the setup request frame. The first or second TIDs may identify latency sensitive traffic for transmission during the trigger-enabled r-TWT SP. The STA may be a member of the trigger-enabled r-TWT SP indicated in the setup response frame. The setup request frame may be a TWT setup request frame. The setup response frame may be a TWT setup response frame. The trigger-enabled r-TWT SP may be a period of time during which the one or more STAs are awake to transmit and/or receive MSDUs or A-MSDUs carrying traffic with a TID from among the one or more first or second TIDs. A TID of the first or second TIDs may indicate a priority of an MSDU by identifying traffic categories (TCs) and traffic streams (TSs). The setup request frame may comprise a bitmap indicating the one or more first TI Ds for downlink traffic, and the setup response frame may comprise a bitmap indicating the one or more second TI Ds for uplink traffic. The setup request frame or the setup response frame may comprise a value of the first time period.

The first frame may be a beacon frame, a probe response frame, a fast initial link setup (FI LS) discovery frame, a TIM broadcast frame, a TWT Setup frame, or an association response frame. The first frame may be broadcast or individually addressed by the AP. The first frame may comprise a target wake time (TWT) element, wherein the TWT element indicates scheduling information of the trigger-enabled r-TWT SP. The first frame is transmitted periodically. The first frame may comprise an address of the AP.

1. A station (STA) comprising:
one or more processors; and
memory storing instructions that, when executed by the one or more processors, cause the STA to:
receive, from an access point (AP), a first frame indicating a trigger-enabled restricted target wake time (r-TWT) service period (SP) for the STA; and
based on not receiving a second frame from the AP during a first time period within the trigger-enabled r-TWT SP, transmit a non-trigger based frame to the AP.

2. The STA of claim 1, wherein the instructions, when executed by the one or more processors, further cause the STA to transmit the non-trigger based frame using a contention-based channel access scheme.

3. The STA of claim 1, wherein transmission of the non-trigger based frame terminates the trigger-enabled r-TWT SP.

4. The STA of claim 1, wherein the instructions, when executed by the one or more processors, further cause the STA to transmit the non-trigger based frame at a pre-determined time after the first time period ends.

5. The STA of claim 1, wherein the instructions, when executed by the one or more processors, further cause the STA to transmit the non-trigger based frame based on the first time period ending prior to a predetermined time before the end of the trigger-enabled r-TWT SP.

6. The STA of claim 1, wherein the second frame comprises a trigger frame.

7. The STA of claim 1, wherein the instructions, when executed by the one or more processors, further cause the STA to:
transmit, to the AP, a setup request frame indicating one or more first traffic identifiers (TIDs) associated with the trigger-enabled r-TWT SP; and
receive, from the AP, a setup response frame indicating one or more second TIDs associated with the trigger-enabled r-TWT SP.

8. The STA of claim 1, wherein the STA is a member of the trigger-enabled r-TWT SP.

9. The STA of claim 1, wherein the instructions, when executed by the one or more processors, configure the STA to receive a trigger frame from the AP before transmitting during the trigger-enabled r-TWT SP.

10. The STA of claim 1, wherein the instructions, when executed by the one or more processors, further cause the STA to determine the first time period based on an access category of a traffic identifier (TID) associated with the trigger-enabled r-TWT SP.

11. An access point (AP) comprising:
one or more processors; and
memory storing instructions that, when executed by the one or more processors, cause the AP to:
transmit a first frame indicating:
a restricted target wake time (r-TWT) service period (SP) for one or more stations (STAs); and
a quiet interval, wherein the quiet interval starts with a start time of the r-TWT SP and overlaps with a portion of the r-TWT SP;
determine, based on not receiving a second frame during a first time period of the r-TWT SP, that a wireless medium is not used by the one or more STAs, wherein the first time period starts with the start time of the r-TWT SP; and
based on the determining, transmit a third frame indicating termination of the r-TWT SP.

12. The AP of claim 11, wherein the second frame comprises at least one of:
a medium access control (MAC) service data unit (MSDU) with a traffic identifier (TID) associated with the r-TINT SP;
a request to send (RTS) frame;
a power save-poll (PS-Poll) frame; and
a quality of service (QoS) Null frame.

13. The AP of claim 11, wherein the instructions, when executed by the one or more processors, further cause the AP to:
transmit, during the r-TWT SP, a request frame soliciting the one or more-STAs for uplink transmission, and
determine that the wireless medium is not used based on not receiving a response frame in response to the request frame.

14. The AP of claim 13, wherein the third frame comprises:
a control frame;
a contention free-end (CF-End) frame;
a quality of service (QoS) Data frame; or
a QoS Null frame.

15. The AP of claim 14, wherein the QoS Null frame or the QoS Data frame comprises at least one of:
an aggregate control (A-Control) field indicating termination of r-TWT SP; or
a QoS Control field with an end of service period (EOSP) field set to 1.

16. The AP of claim 14, wherein the control frame comprises a field indicating termination of the r-TWT SP.

17. The AP of claim 11, wherein the instructions, when executed by the one or more processors, further cause the AP to determine the first time period based on an access category of a traffic identifier (TID) associated with the r-TWT SP.

18. The AP of claim 11, wherein the instructions, when executed by the one or more processors, further cause the AP to determine that the wireless medium is used during the r-TWT SP based on:
receiving a PHY-RXSTART.Indication; or
receiving a frame from a STA belonging to a Basic Service Set (BSS) of the AP.

19. The AP of claim 11, wherein the instructions, when executed by the one or more processors, further cause the AP to maintain the r-TWT SP in response to:
receiving a medium access control (MAC) service data unit (MSDU) with a traffic identifier (TID) associated with the r-TWT SP;
receiving a request to send (RTS) frame from a STA of the one or more STAs; or
receiving a response frame from a STA in response to a request frame.

20. A non-transitory computer-readable medium comprising instructions that, when executed by a processor of station (STA), cause the STA to:
receive, from an access point (AP), a first frame indicating a trigger-enabled restricted target wake time (r-TWT) service period (SP) for the STA; and
based on not receiving a second frame from the AP during a first time period within the trigger-enabled r-TWT SP, transmit a non-trigger based frame to the AP.
